(19) United States
(12) Patent Application Publication
(10) Pub. No.: US 2026/0178252 A1
(43) Pub. Date: Jun. 25, 2026

(54) INFORMATION PROCESSING APPARATUS, CONTROL METHOD OF INFORMATION PROCESSING APPARATUS, AND NON-TRANSITORY COMPUTER-READABLE STORAGE MEDIUM

(71) Applicant: CANON KABUSHIKI KAISHA, Tokyo (JP)

(72) Inventor: MASARU ITO, Kanagawa (JP)

(21) Appl. No.: 19/417,702

(22) Filed: Dec. 12, 2025

(30) Foreign Application Priority Data
Dec. 23, 2024 (JP) 2024-226525

(51) Int. Cl. G06F 3/12

(52) U.S. Cl. CPC G06F 3/1258; G06F 3/1205

(57) ABSTRACT

An information processing apparatus, if a print instruction using a print queue selected by a user is input, controls to display a selection screen including an option configured to cause the user to select a print method when performing print processing based on the selected print queue and a setting indicating whether to perform print using the same print method even next time; and transmits a print job to a print service in accordance with the selected print method, wherein if the setting to perform print using the same print method even next time is done in the selection screen, and if a next print instruction using the print queue is input by the user, the information processing apparatus further controls not to display the selection screen.

### BACKGROUND

### Field of the Technology

The present disclosure relates to an information processing apparatus, a control method of the information processing apparatus, and a non-transitory computer-readable storage medium.

### Description of the Related Art

Conventionally, there have been developed image forming systems including a plurality of PCs (personal computers) and a plurality of image forming apparatuses (for example, Multifunction Peripherals). When setting a print method using such an image forming apparatus, a user can select a print queue corresponding to direct print that can execute print in a specific image forming apparatus in accordance with a print job transmission instruction. The user can also select a print queue corresponding to anywhere print (to be also referred to as hold print hereinafter) that can execute print in an arbitrary image forming apparatus at an arbitrary timing.

Here, the print queue for performing direct print is a software module that extracts spooled print data in the first-in first-out order and transmits it to the image forming apparatus of the output destination designated in advance. Note that the print queue for performing direct print is added to the PC for each image forming apparatus that is the output destination. On the other hand, the print queue for performing anywhere print is linked with a server that holds the print job or manages job information. If the user instructs anywhere print in the PC, the print job and the job information are held in the server. After that, when the user logs in to an arbitrary image forming apparatus, the image forming apparatus can inquire of the server about the presence/absence of the print job, acquire the print job, and perform print. Hence, when one print queue for performing anywhere print is added to the PC, print can be performed by any of the plurality of image forming apparatuses.

Also, recently, cloud print services have been developed in which a user inputs a print instruction from a terminal such as a PC to an image forming apparatus via a cloud server. In the cloud print service, image forming apparatuses, user information, information of terminals that input instructions, and the like are registered and managed on the cloud server in advance. The user can, for example, log in to the cloud server, select a desired image forming apparatus, and transmit an instruction such that the image forming apparatus performs print. However, selecting an image forming apparatus every time a print instruction is input increases user's time and effort and causes workload. In Japanese Patent Laid-Open No. 2021-121076, an image forming apparatus for normal use (to be also referred to as a default printer hereinafter) is managed for each user on a cloud server, thereby reducing burden that is generated for the user who selects an image forming apparatus every time a print instruction is input.

In Japanese Patent Laid-Open No. 2021-121076, since default printer information is managed on the cloud server, the default printer can easily be set. In Japanese Patent Laid-Open No. 2021-121076, however, a print service that provides both anywhere print and direct print has not been examined. On the other hand, when performing direct print, the user needs to select a print queue corresponding to direct print. Hence, in a situation where a print queue for anywhere print is introduced into a PC but a print queue corresponding to direct print is not introduced, when performing direct print, the print queue for direct print needs to be added to the PC. However, for example, if the user wants to decrease work time when printing an urgent material or continuously printing a plurality of types of files, introduction of the print queue corresponding to direct print requires time and, therefore, the user feels stressed. As described above, if the user wants to change the print method, the system that requires addition of a new print queue for direct print to a terminal such as a PC lowers usability.

### SUMMARY

The present disclosure enables realization of a new mechanism that suppresses lowering of usability when a user who uses a cloud print service changes a print method.

One aspect of the present disclosure provides an information processing apparatus comprising: one or more memory devices that store a set of instructions; and one or more processors that execute the set of instructions to: if a print instruction using a print queue selected by a user is input, control to display a selection screen including an option configured to cause the user to select a print method when performing print processing based on the selected print queue and a setting indicating whether to perform print using the same print method even next time; and transmit a print job to a print service in accordance with the selected print method, wherein the one or more processors further execute instructions in the one or more memory devices to: if the setting to perform print using the same print method even next time is done in the selection screen, and if a next print instruction using the print queue is input by the user, control not to display the selection screen.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic view of an image forming system according to an embodiment;

FIG. 2A is a view showing the hardware configuration of an image forming apparatus according to the embodiment;

FIG. 2B is a view showing the hardware configuration of a cloud print service according to the embodiment;

FIG. 2C is a view showing the hardware configuration of an information processing terminal according to the embodiment;

FIG. 3 is a view showing the software configuration of the image forming apparatus according to the embodiment;

FIG. 4 is a view showing the software configuration of the cloud print service according to the embodiment;

FIG. 5 is a view showing the software configuration of the information processing terminal according to the embodiment;

FIG. 6 is a sequence chart showing a processing procedure according to the embodiment;

FIG. 7 is a view showing a display screen according to the embodiment;

FIG. 8A is a view showing the information of the image forming apparatus according to the embodiment;

FIG. 8B is a view showing the information of the image forming apparatus according to the embodiment;

FIG. 8C is a view showing the information of the image forming apparatus according to the embodiment;

FIG. 9 is a sequence chart showing a processing procedure according to the embodiment;

FIG. 10 is a view showing a display screen according to the embodiment;

FIG. 11A is a view showing a display screen according to the embodiment;

FIG. 11B is a view showing a display screen according to the embodiment;

FIG. 12 is a sequence chart showing a processing procedure according to the embodiment;

FIG. 13A is a view showing a display screen according to the embodiment;

FIG. 13B is a view showing a display screen according to the embodiment;

FIG. 14 is a view showing a display screen according to the embodiment;

FIG. 15 is a flowchart showing a processing procedure according to the embodiment;

FIG. 16 is a sequence chart showing a processing procedure according to the embodiment;

FIGS. 17A and 17B are views showing a display screen according to the embodiment;

FIG. 18A is a view showing a display screen according to the embodiment;

FIG. 18B is a view showing a display screen according to the embodiment;

FIG. 19 is a flowchart showing a processing procedure according to the embodiment;

FIGS. 20A, 20B, and 20C are explanatory views of table information registered in a database according to the embodiment;

FIG. 21 is a sequence chart showing a processing procedure according to the embodiment;

FIG. 22 is a view showing a display screen according to the embodiment;

FIG. 23 is a view showing a display screen according to the embodiment; and

FIG. 24 is a flowchart showing a processing procedure according to the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In this specification, term "image forming apparatus" broadly includes apparatuses that form (print) an image on a print material (print medium), such as a single function printer, a copying machine, a multifunction peripheral, and a commercial print press.

In this specification, full function print includes print in which a printer driver generates a print setting screen including all print setting items that a target image forming apparatus can set, and a user can designate all the print settings via the print setting screen.

### First Embodiment

### System Configuration

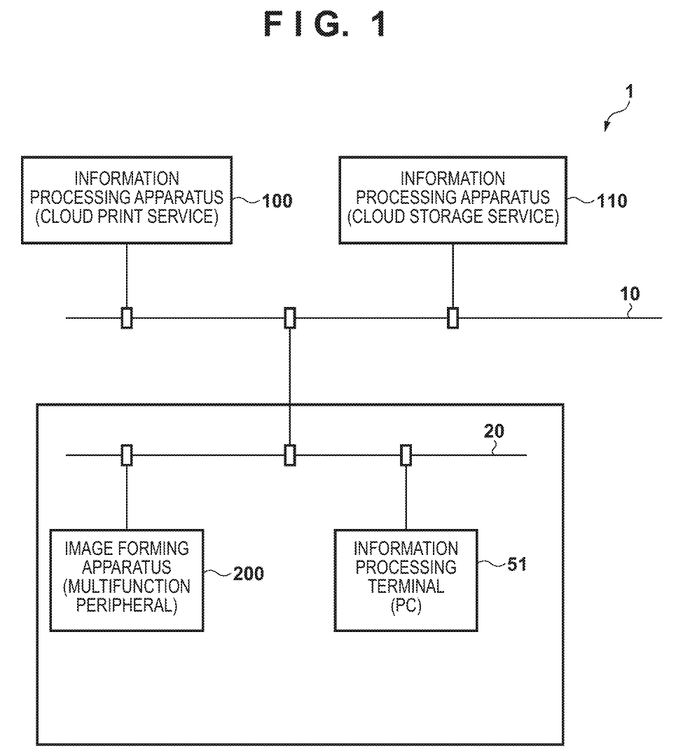

The configuration of an image forming system 1 according to this embodiment will be described with reference to FIG. 1. The image forming system 1 is configured to include, for example, an information processing apparatus 100, an information processing apparatus 110, an information processing terminal 51, and an image forming apparatus 200, and these are connected via a network 10 or 20. Here, in the image forming system 1, a manager sometimes manages, in the information processing apparatus 100, a single or a plurality of image forming apparatuses 200 together in, for example, a company or in a unit of organizations belonging to a company. In this case, the unit of management is also called "tenant".

The information processing apparatus 100 is a server hosting on a cloud platform and provides a Web portal to a connected client. Particularly, the information processing apparatus 100 has the function of a cloud print server that provides a cloud print service concerning print. The information processing apparatus 100 will sometimes be referred to as the cloud print service 100 hereinafter. Also, the information processing apparatus 110 provides a general-purpose cloud storage service such as Google Drive ^{®}. The information processing apparatus 110 will sometimes be referred to as the cloud storage service 110 hereinafter.

The image forming apparatus 200 is a digital multifunction peripheral having a plurality of functions such as a copy function, a scan function, a print function, a FAX function, and an email transmission function. The image forming apparatus 200 may be a printer having a single function. Note that the image forming apparatus 200 will be described as a printer hereinafter. FIG. 1 shows one image forming apparatus 200, but the number of image forming apparatuses 200 is not limited to one.

The information processing terminal 51 is, for example, a personal computer (PC) but may be an information processing terminal such as a smartphone or a tablet. The information processing terminal 51 is an example of "information processing apparatus capable of communicating with a cloud print server". The local network 20 is, for example, a network in a company office, and FIG. 1 exemplifies that a plurality of image forming apparatuses 200 used by a plurality of employees and the information processing terminal 51 are connected in the company office.

The image forming apparatuses 200 and the information processing terminal 51 can communicate with the cloud print service 100 via the network 10 and use a Web portal or a print service provided by the cloud print service 100. Similarly, the image forming apparatuses 200 can communicate with the cloud storage service 110 via the network 10 and use a file service provided by the cloud storage service 110.

### Hardware Configuration of Image Forming Apparatus 200

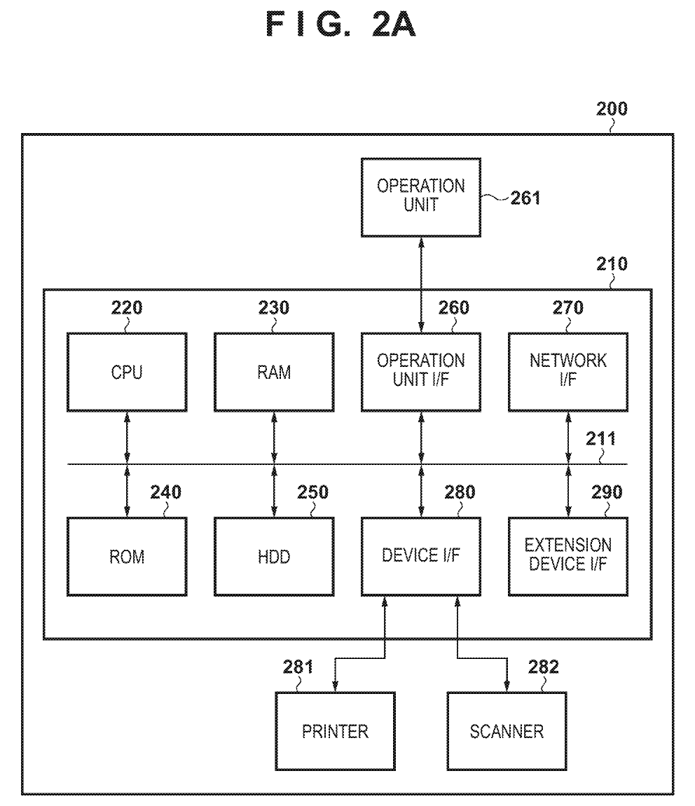

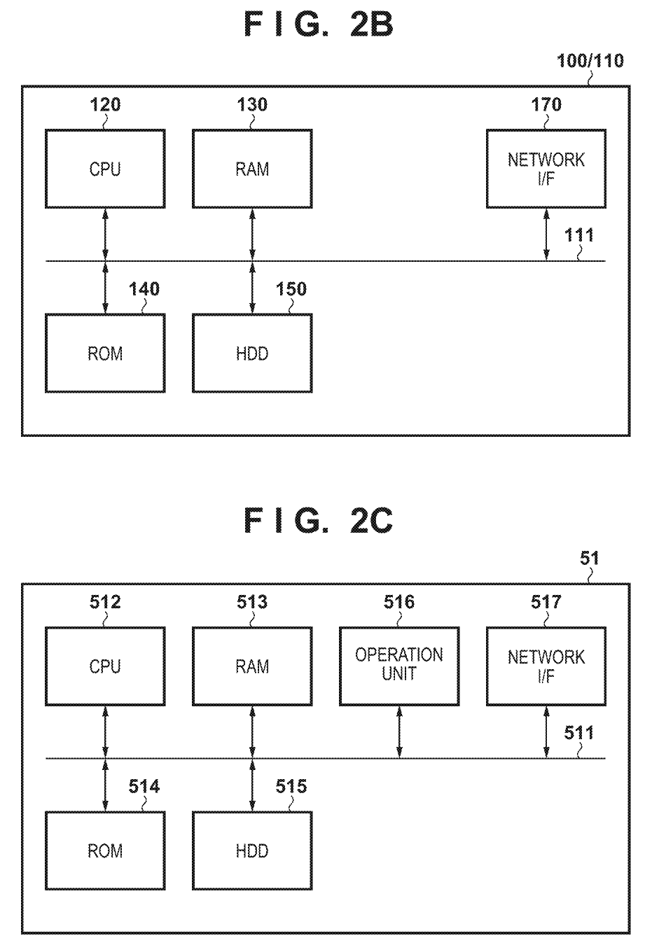

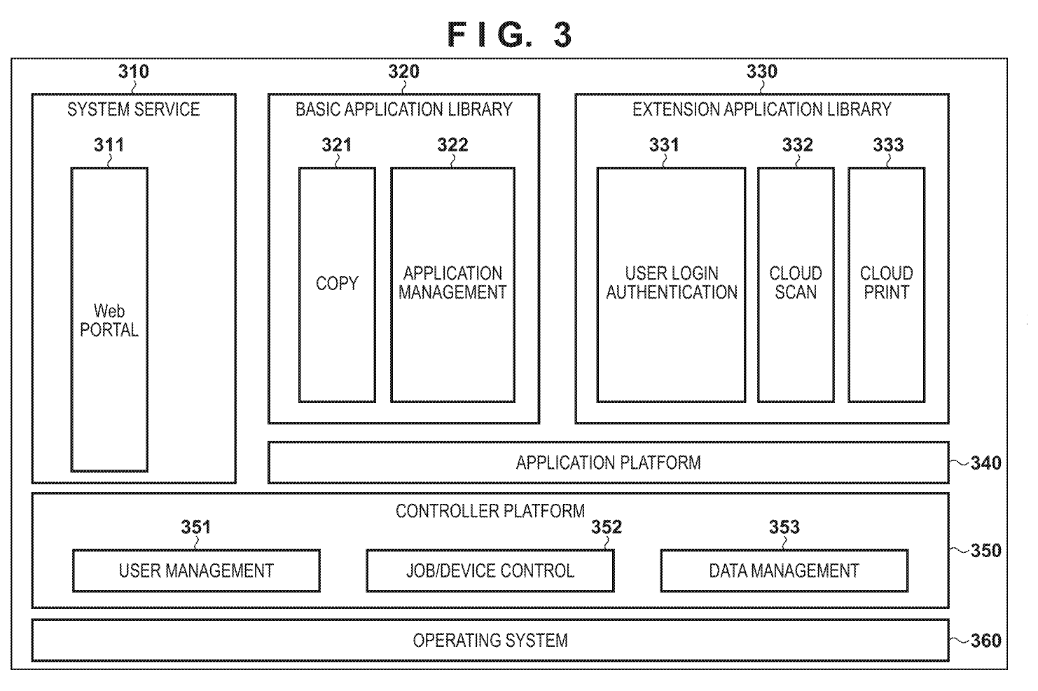

The hardware configuration of the image forming apparatus 200 will be described with reference to FIG. 2A. The image forming apparatus 200 is, for example, a digital multifunction peripheral, and is configured to include a controller unit 210, an operation unit 261, a printer 281, and a scanner 282. The controller unit 210 is configured to include a CPU 220, a RAM 230, a ROM 240, an HDD 250, an operation unit I/F 260, a network I/F 270, a device I/F 280, and an extension device I/F 290.

The CPU 220 is an execution medium for a control program incorporated in the image forming apparatus 200, and controls the operation of a device connected to the controller unit via each I/F and the memory of a storage medium. The RAM 230 stores programs such as an operating system, system software, and application software and data. The ROM 240 stores the boot program of the system, system programs, and application programs. Also, information necessary for the image forming apparatus 200, for example, fonts are stored in some cases. The HDD 250 is a storage device having a large capacity, as compared to the RAM 230, and stores an operating system, system software, application software, image data, setting data, print jobs, user information, and the like. When the CPU 220 executes a program stored in the ROM 240, a program stored in the HDD 250 is deployed on the RAM 230. Next, the CPU 220 executes the program deployed on the RAM 230, thereby processing data stored in the RAM 230, the ROM 240, or the HDD 250. In a case of a compact multifunction peripheral, the HDD 250 may not be mounted, and the system software, the application software, and the like are stored in the ROM 240. Alternatively, not the HDD 250 but a storage device other than a hard disk, for example, a flash memory such as a Solid State Disk (SSD) may be used.

The operation unit I/F 260 is an interface unit that performs input/output control to the operation unit 261 that is configured to include, for example, a touch panel, and outputs, to the operation unit 261, image data to be displayed on the operation unit 261. In addition, the operation unit I/F 260 transmits input information that the user inputs by operating the operation unit 261 to the CPU 220. The network I/F 270 is configured to include a communication module, and is connected to a network and communicates with an external device on the network.

The device I/F 280 connects the printer 281 or the scanner 282, which is an image input/output device, and the controller unit 210 and inputs or outputs image data. The CPU 220 controls the scanner 282, thereby reading an original image and storing the read image data in the RAM 230 or the HDD 250 via the device I/F 280. For the stored image data, image processing is executed as needed by an application program deployed on the RAM 230. Also, the CPU 220 outputs image data to the printer 281 via the device I/F 280 and controls the printer 281, thereby printing the image data on a sheet.

The extension device I/F 290 is configured to include, for example, a USB port that enables connection of an arbitrary optional device or a wireless transceiver such as Bluetooth. By the extension device I/F 290, for example, an optional device such as an ID card reader or a biometric authentication device can be connected to the image forming apparatus 200.

Note that the image forming apparatus 200 is not limited to the configuration shown in FIG. 2A. For example, the image forming apparatus 200 may be a printer that does not include the scanner 282. If the image forming apparatus 200 is a multifunction peripheral with a FAX function, an I/F for modem device (not shown in FIG. 2A) may be provided in the controller unit 210, and the image forming apparatus 200 may be connected to a public line by the modem for FAX transmission.

### Hardware Configuration of Cloud Print Service 100

The hardware configuration of the cloud print service 100 will be described with reference to FIG. 2B. The cloud print service 100 is configured to include a CPU 120, a RAM 130, a ROM 140, an HDD 150, and a network I/F 170, and these are connected to each other by a bus 111. The CPU 120 reads out a control program stored in the ROM 140 and executes various kinds of processing, thereby controlling the overall operation. The RAM 130 is used as a temporary storage area such as the main memory or work memory of the CPU 120. The HDD 150 is a mass storage unit that stores image data and various kinds of programs. The network I/F 170 is an interface configured to include a communication module and used to connect to the Internet. Note that the hardware configuration of the cloud storage service 110 is the same as, for example, the hardware configuration of the cloud print service 100 shown in FIG. 2B.

### Hardware Configuration of Information Processing Terminal 51

The hardware configuration of the information processing terminal 51 will be described with reference to FIG. 2C. The information processing terminal 51 is configured to include a CPU 512 (an example of "display control unit"), a RAM 513, a ROM 514, an HDD 515 (an example of "storage unit"), an operation unit 516, and a network I/F 517, and these are connected to each other by a bus 511. The CPU 512 reads out a control program stored in the ROM 514 and executes various kinds of processing, thereby controlling the overall operation. The RAM 513 is used as a temporary storage area such as the main memory or work memory of the CPU 512. The HDD 515 is a mass storage unit that stores image data and various kinds of programs. The operation unit 516 is configured to include, for example, input devices such as a keyboard and a mouse and an output device such as a display. The operation unit 516 is an interface configured to input operation signals to the information processing terminal 51 and display a result of processing by the information processing terminal 51. The network I/F 517 is an interface used to connect to the Internet and is configured to include a communication module.

### Software Configuration of Image Forming Apparatus 200

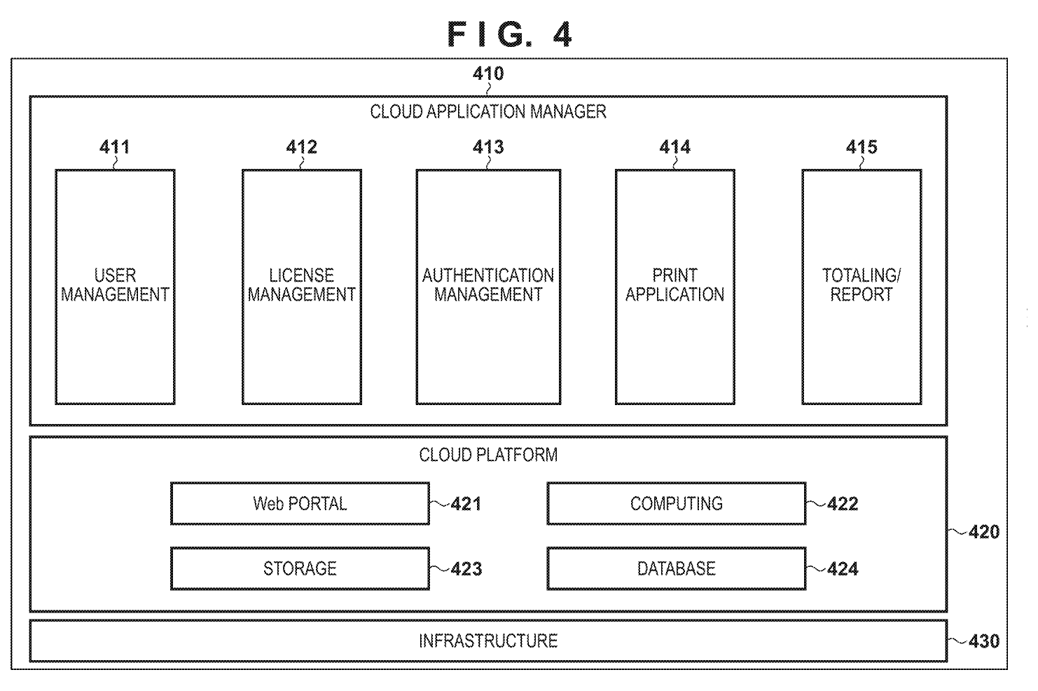

The software configuration of a program to be executed by the CPU 220 of the image forming apparatus 200 will be described with reference to FIG. 3. An operating system (OS) 360 provides, to software operating thereon, the service and framework of various kinds of resource management optimized for control of an embedded system. More specifically, the service and framework of various kinds of resource management include multitask management in which a plurality of execution contexts of processing by the CPU 220 are managed, thereby substantially parallelly operating a plurality of processes, and inter-task communication that implements synchronization or data exchange between tasks. Furthermore, the operating system 360 provides, for example, memory management, interrupt management, various kinds of device drivers and local interfaces, and a protocol stack that implements processing of various kinds of protocols such as network and communication.

A controller platform 350 is configured to include user management 351, job/device control 352, and data management 353. The user management 351 provides, to an application, a mechanism for managing a local user in the image forming apparatus 200 and authentication information thereof using the RAM 230 or the HDD 250. A login application implements user login control to the image forming apparatus 200 using the authentication information of the local user managed by the user management 351. The job/device control 352 executes a print job such as scan, print, or copy while controlling the printer 281 and the scanner 282 in accordance with an instruction from an application. Also, the job/device control 352 manages the device states of the printer 281 and the scanner 282 and errors in the devices.

The data management 353 manages image data and various kinds of setting data necessary when executing a print job. The data management 353 also manages a job execution history, counter information, various kinds of data controlled by applications, and the model information and capability information of the image forming apparatus 200.

A system service 310 is a software module that manages program updating of the controller platform 350 and the operating system and device information/network setting, and the like. Furthermore, the system service 310 is configured to include a Web portal 311 and can be operated from a remote terminal such as the information processing terminal 51.

An application platform 340 is middleware usable from various kinds of applications. More specifically, the application platform 340 is configured to allow various kinds of applications in a basic application library 320 and an extension application library 330 to be described later to use the mechanisms of the operating system 360 and the controller platform 350.

The basic application library 320 indicates an application group which is stored in the ROM 240 or the HDD 250 in an initial state at the time of purchase of the image forming apparatus 200 and provides the basic functions of the image forming apparatus 200. The extension application library 330 indicates an arbitrary application group that is individually installed and operates to extend the functions implemented by the image forming apparatus 200. Each application displays a screen on the operation unit 261 and implements various kinds of functions in accordance with a user operation accepted by the operation unit 261.

FIG. 3 shows an example in which copy 321 and application management 322 are included in the basic application library 320. The copy 321 is an application configured to execute a copy job that scans an original and prints an image on paper. The application management 322 is an application configured to manage installation and uninstallation of an extension application in the extension application library 330.

As an example, FIG. 3 shows a state in which extension applications of user login authentication 331, cloud scan 332, and cloud print 333 are installed as the extension application library 330. The user login authentication 331 is an application that displays, on the operation unit 261, a screen for inputting user authentication information, and implements user login processing to the image forming apparatus 200 using the user authentication information input from the operation unit 261. The user login processing is implemented using not only the user authentication information input from the operation unit 261 but also user authentication information read from an ID card reader or a biometric authentication device connected via the extension device I/F 290. The user login authentication 331 communicates with the cloud print service 100 via the network I/F 270. The user login authentication 331 then performs user authentication by collating user authentication information managed on the cloud print service 100 with the user authentication information input to the image forming apparatus 200. In the user login authentication 331, user authentication may be performed by collation with user authentication information managed by the user management 351.

The cloud scan 332 is an application that communicates with the unspecified cloud storage service 110 and transmits an image file read by executing a scan job by the image forming apparatus 200 to the cloud storage service 110. The cloud print 333 is an application that communicates with the cloud print service 100, acquires print target image data from the cloud print service 100, and executes a print job by the image forming apparatus 200. The cloud print 333 may be able to acquire print target file data from the cloud storage service 110 and execute a print job by the image forming apparatus. Also, the cloud print 333 transmits the print job execution result to the cloud print service 100.

### Software Configuration of Cloud Server

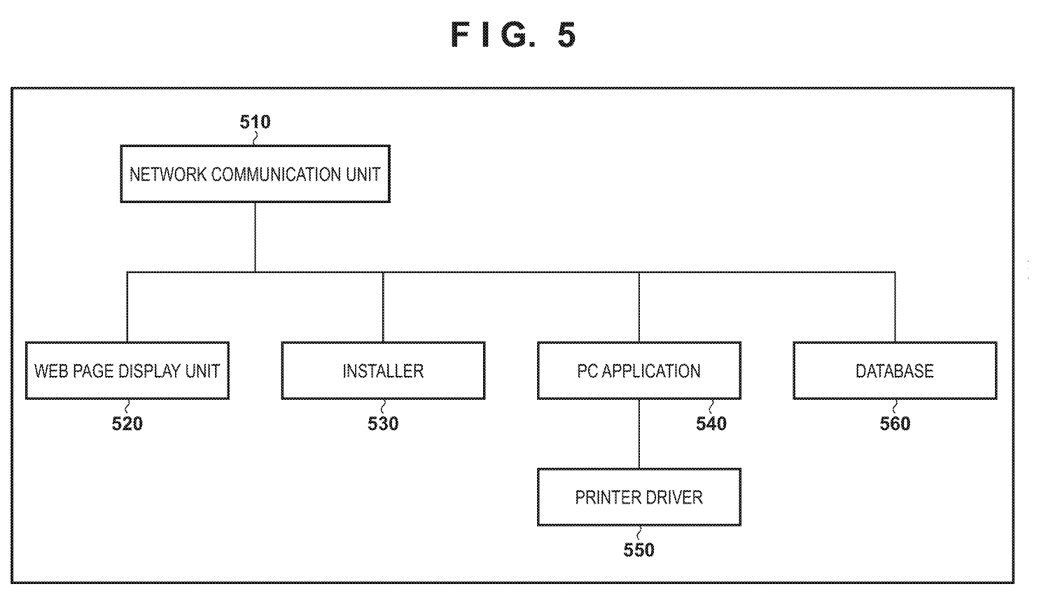

The software configuration of the cloud print service 100 will be described with reference to FIG. 4. An infrastructure 430 is the base for the cloud server to provide various kinds of services and is configured to include a server, a virtual machine, a cloud storage, a network, and an operating system.

A cloud platform 420 is a framework that provides a common basic function to a cloud application manager 410 using the infrastructure 430. That is, the cloud platform 420 is configured to include a Web portal 421, computing 422, a storage 423, and a database 424.

The cloud application manager 410 indicates various kinds of application groups operating on the cloud platform 420. The cloud application manager 410 is configured to include user management 411, license management 412, authentication management 413, a print application 414, and totaling/report 415.

The user management 411 centrally manages user information on the cloud print service 100. Registration/deletion of a user is executed from the operation panel of the image forming apparatus 200. The user management 411 manages user information of a target using the database 424. Also, the user management 411 provides an API for accepting a user authentication instruction from the user login authentication 331 or a PC application operating on the image forming apparatus 200.

The license management 412 is a Web application that provides a Web service screen for centrally managing applications on the cloud print service 100 using the Web portal 421. By the Web service screen, the user can perform installation, license registration, and uninstallation of a management target application. The license management 412 is also a Web application that provides an API for accepting a license registration instruction from the user login authentication 331 or the application management 322 operating on the image forming apparatus 200. In some cases, license registration instructed from the application management 322 of the image forming apparatus 200 succeeds. In this case, the license management 412 acquires an application that operates on the image forming apparatus 200 and uses the cloud print service 100 from the storage 423 and provides it to the image forming apparatus 200.

The authentication management 413 is a Web application that provides a Web service screen for setting a user login authentication method using the Web portal 421. By the Web service screen, it is possible to set a user login authentication method of each application centrally managed on the cloud print service 100. The authentication management 413 also manages the user login authentication method of a target using the storage 423 or the database 424. The authentication management 413 is also a Web application that provides an API for accepting a setting information acquisition instruction from the user login authentication 331 operating on the image forming apparatus 200. Also, the authentication management 413 controls access to various kinds of Web service screens provided by the cloud application manager 410 and user authentication at the time of API call.

The user management 411, the license management 412, and the authentication management 413 executed on the cloud print service 100 and the user login authentication 331 executed on the image forming apparatus 200 can perform a cooperative operation. By the cooperative operation, it is possible to log in to a device cooperating with the cloud print service 100 using the centrally managed user authentication method and authentication information.

The print application 414 is a Web application that provides an API for accepting a print target document acquisition instruction and a print execution instruction from the cloud print 333 executed on the image forming apparatus 200 using the Web portal 421. The print application 414 also provides an API for accepting a print execution instruction from a PC application. The print application 414 accepts a print target document acquisition instruction and returns a list of print target documents existing in a target cloud storage. In addition, the print application 414 can accept a print execution instruction and convert a document into a data format printable by the image forming apparatus 200 using the computing 422. The print application 414 is also a Web application that provides an API for accepting a print job transmitted from a PC application in the information processing terminal 51 and an API for accepting a print job acquisition instruction from the cloud print 333. The print application 414 on the cloud server and the cloud print 333 executed on the image forming apparatus 200 can perform a cooperative operation. By the cooperative operation, the user can execute the same print workflow on a device cooperating with the cloud print service 100.

The totaling/report 415 is a Web application that provides an API for accepting a job execution result transmitted from the cloud scan 332 and the cloud print 333 executed on the image forming apparatus 200 using the Web portal 421. Also, the totaling/report 415 performs totaling processing of the received job execution result and provides a Web service screen that displays the totaling result using the computing 422.

Note that various kinds of Web service screens and APIs provided by the cloud application manager 410 are individually managed for each tenant. For example, a different URL is generated for each tenant. Various kinds of data managed by the cloud application manager 410 are also individually managed for each tenant.

### Software Configuration of Information Processing Terminal

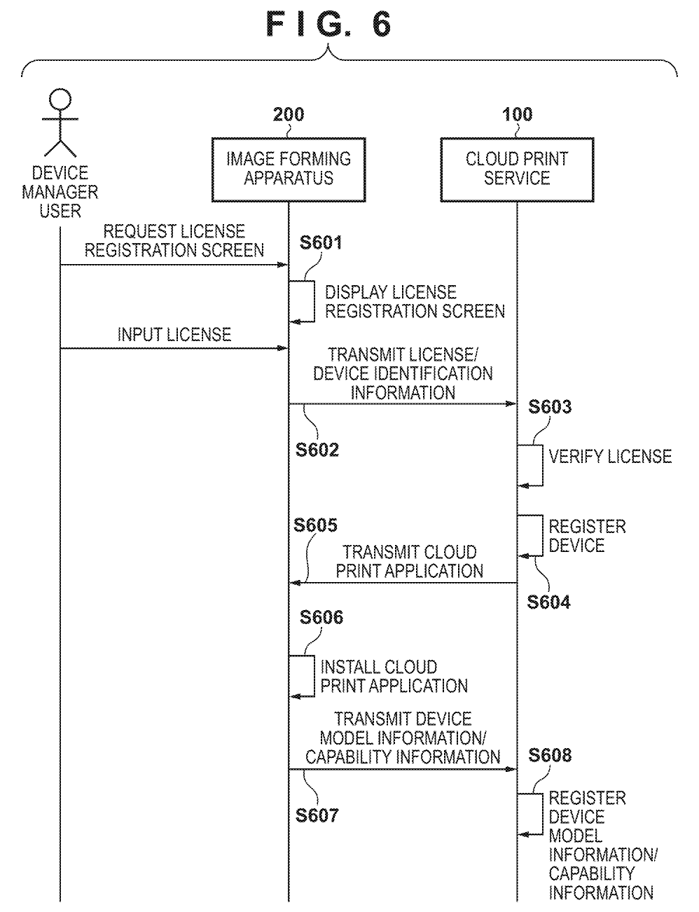

The software configuration of the information processing terminal 51 will be described with reference to FIG. 5. Programs operating on the information processing terminal 51 are configured to include a network communication unit 510, a Web page display unit 520, an installer 530, a PC application 540, a printer driver 550, and a database 560 (an example of "storage unit"). The network communication unit 510 is a module configured to perform data communication with the cloud print service 100 connected via the network (10 or 20). The Web page display unit 520 is a Web browser and performs display of various kinds of Web service screens provided from the cloud print service 100 and acceptance of user operations on the screens. The PC application 540 performs display of a screen and acceptance of an operation on the screen.

The installer 530 is downloaded from the cloud print service 100 together with tenant information. The installer 530 displays a screen on which a printer driver to be installed or an image forming apparatus that is a print destination can be selected. The installer 530 accepts a printer driver that the user selects on the screen and the information of the image forming apparatus. The installer 530 downloads the printer driver and the information of the image forming apparatus from the cloud print service 100 via the network communication unit 510 and installs the printer driver in the information processing terminal 51.

The PC application 540 is a resident application, and transmits (submits) a print job that the printer driver 550 generates in accordance with an instruction of the user to the cloud print service 100 via the network communication unit 510. In addition, the PC application 540 acquires information from the cloud print service 100, converts the information into a configuration information format identifiable by the printer driver 550 as needed, and transmits the configuration information to the printer driver 550.

The printer driver 550 is a printer driver for anywhere print that enables print by an arbitrary image forming apparatus or a printer driver specialized to a specific printer to perform print using a specific printer. The printer driver 550 is selected by the user via the installer 530 and installed in the information processing terminal. Note that a plurality of printer drivers can be installed in the information processing terminal 51. Also, in the information processing terminal 51, a print queue corresponding to each image forming apparatus selected by the user is generated. The database 560 manages a print job transmission method (hold print/direct print) set by the PC application 540 or the information of an output destination device in direct print.

### Registration Processing of Image Forming Apparatus 200 for Cloud Print Service 100

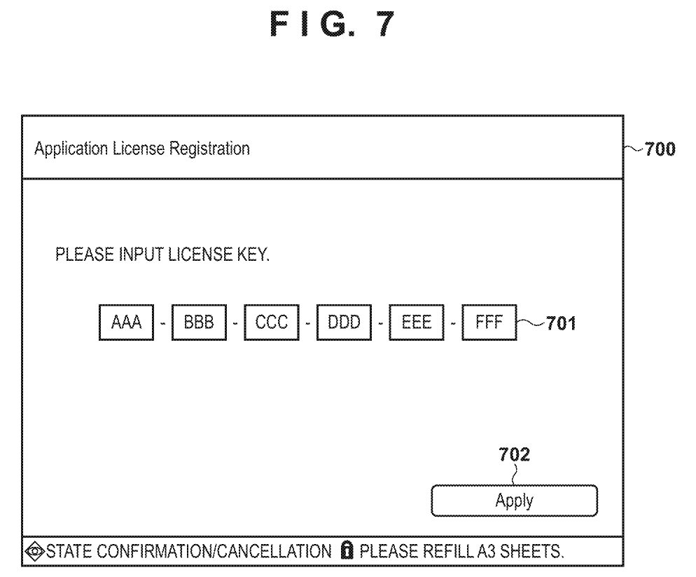

A sequence flow in which the image forming apparatus 200 is registered in the cloud print service 100 and an application configured to use the cloud print service 100 is installed in the image forming apparatus 200 will be described with reference to FIG. 6. This sequence flow is implemented by the image forming apparatus 200 and the cloud print service 100 executing processing while communicating with each other via the network 10. Processing of the image forming apparatus 200 is implemented by reading out a program stored in the ROM 240 to the RAM 230 and executing it by the CPU 220. Similarly, processing of the cloud print service 100 is implemented by reading out a program stored in the ROM 140 to the RAM 130 and executing it by the CPU 120. Also, this sequence flow is executed when the device manager of the image forming apparatus 200 inputs an execution instruction via the operation unit 261.

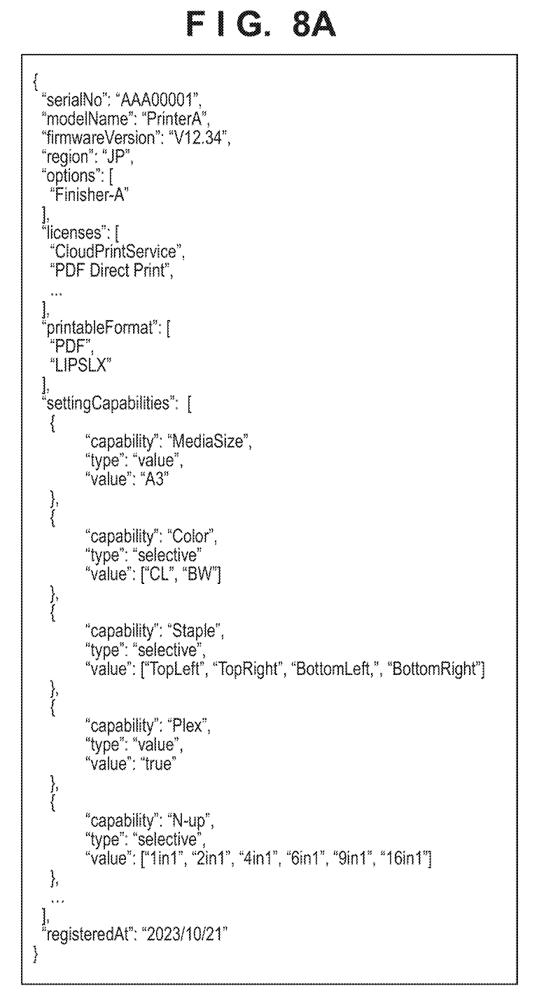

In S601, the application management 322 of the image forming apparatus 200 receives an instruction to request a registration screen for a user license of the cloud print service 100 by the device manager and displays the license registration screen on the operation unit 261. The license registration screen displayed on the operation unit 261 in S601 will be described with reference to FIG. 7. The device manager inputs a license key for extending the function of the image forming apparatus 200, which is obtained in advance, to a license key input field 701 via the operation unit 261. The device manager then performs a touch operation on an Apply icon 702, thereby applying the license to the image forming apparatus 200. Here, the device manager inputs the license key of the cloud print service 100 to the license registration screen displayed in S601.

In S602, the application management 322 transmits the serial number of the image forming apparatus 200 as identification information to the cloud print service 100 via the network I/F 270 together with the input license key. In S603, the cloud print service 100 receives the license key and the serial number in S602 via the network I/F 170 and the license management 412 verifies the license key. If the license management 412 determines that it is an authentic license key associated with the cloud print service 100, the process advances to S604.

In S604, the license management 412 registers, in the database 424, the image forming apparatus 200 of the serial number received in S603 as a device capable of using the cloud print service 100. Note that if the same manager executes the processes of S601 to S604 for a plurality of image forming apparatuses 200, the plurality of image forming apparatuses 200 are set such that these belong to the same tenant.

In S605, the license management 412 transmits an application for using the cloud print service 100 to the image forming apparatus 200 via the network I/F 170. In S606, the application management 322 of the image forming apparatus 200 installs the received application for using the cloud print service in the image forming apparatus 200. This processing makes the cloud print 333 shown in FIG. 3 usable in the image forming apparatus 200. In S607, the cloud print 333 acquires the model information and capability information of the image forming apparatus 200 from the data management 353 and transmits these to the cloud print service 100 via the network I/F 270.

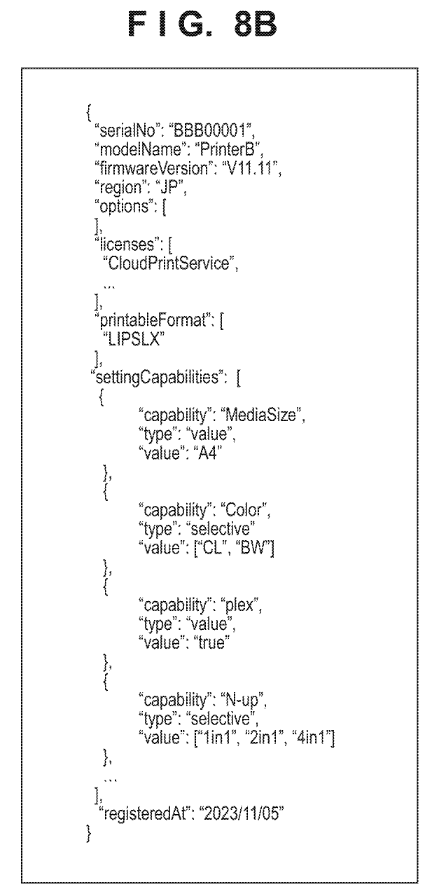

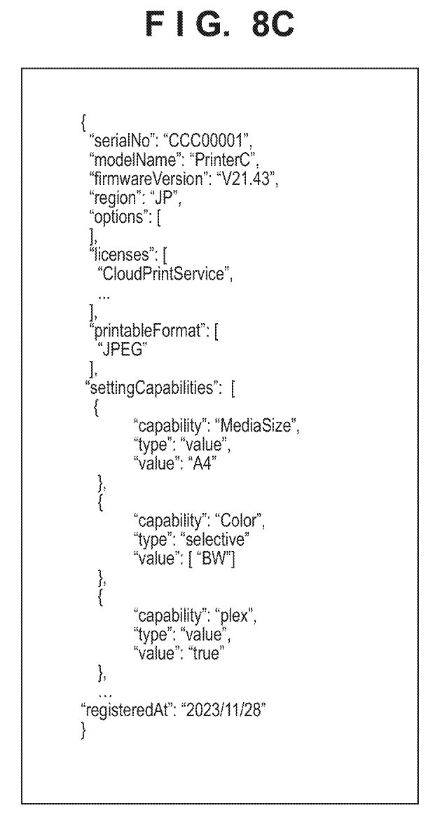

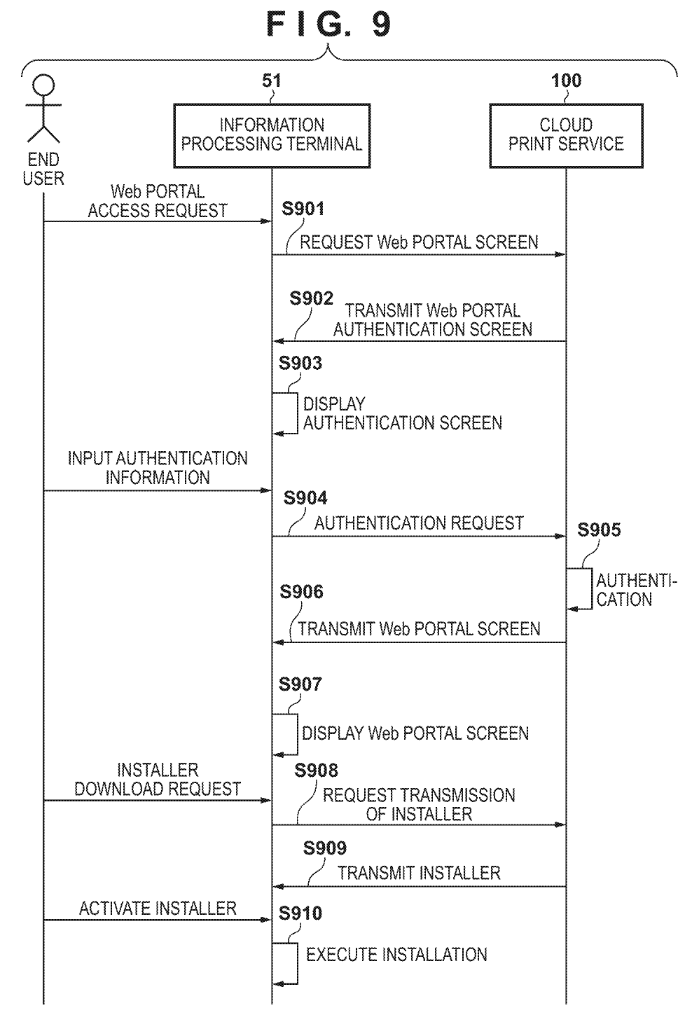

Model information and capability information each of a plurality of image forming apparatuses 200 transmits, by the cloud print 333, in S607 will be described with reference to FIGS. 8A to 8C. In the examples shown in FIGS. 8A to 8C, "serialNo" indicates a serial number, "modelName" indicates a model, and "firmwareVersion" indicates a firmware version. Also, "region" indicates a destination country, "options" indicates an attachment such as a finisher to the image forming apparatus, and "licenses" indicates a registered license list. In addition, "printableFormat" indicates a printable data format, "settingCapabilities" indicates print settings usable in the image forming apparatus 200. Also, "registeredAt" indicates a registration date/time, and "settingCapabilities" indicates the capability information of the image forming apparatus 200. The "settingCapabilities" further includes items "capability", "type", and "value" for each usable print setting, "capability" indicates the item name of the print setting, "type" indicates the type of a print setting value, and "value" indicates the range of the usable print setting.

More specifically, in FIG. 8A, in the image forming apparatus 200 whose "serialNo" is "AAA00001", an output paper size setting "MediaSize" is a set value defined by "value" that is "A3" here. This indicates that the image forming apparatus 200 of "AAA00001" provides a function of print or the like with paper of A3 standard. A color setting "Color" is a set value defined by "selective", and it is indicated here that "CL" representing color or "BW" representing monochrome can be selected at the time of print.

A staple setting "Staple" is a set value defined by "selective". It is indicated here that a position where stapling is possible can be selected from four points including the upper left point "TopLeft" of the output paper, the upper right point "TopRight", the lower left point "BottomLeft", and the lower right point "BottomRight". A double-sided setting "Plex" is a set value defined by "value", and the value is "true", that is, double-sided print is possible. An N-up print setting "N-up" is a set value defined by "selective", and it is indicated that the value can be selected from N-up print setting values "1in1", "2in1", "4in1", "6in1", "9in1", and "16in1".

Next, the difference of FIG. 8B from FIG. 8A will be described. In FIG. 8B, in the image forming apparatus 200 whose "serialNo" is "BBB00001", the set value of the paper size setting "MediaSize" is "A4" that provides a function of print or the like with paper of A4 standard. In addition, the staple setting "Staple" is unusable, and only "1in1", "2in1", and "4in1" can be used as the N-up print setting "N-up". Next, the difference of FIG. 8C from FIG. 8A will be described. In FIG. 8C, in the image forming apparatus 200 whose "serialNo" is "CCC00001", only monochrome "BW" can be selected as the color setting "Color". It is indicated that staple setting "Staple" and the N-up print setting "N-up" are unusable.

Referring back to the flowchart of FIG. 6, in S608, the print application 414 of the cloud print service 100 receives the model information and capability information of the image forming apparatus 200 via the network I/F 170. The print application 414 then searches the registered serial numbers for a number that matches the serial number included in the received model information and capability information. The received model information and capability information are linked with the matching serial number and registered in the database 424. The sequence flow is thus ended. When the above-described sequence flow is executed, the image forming apparatus 200 is registered in the cloud print service 100 as a device capable of using the cloud print service 100.

### Installer Download Processing

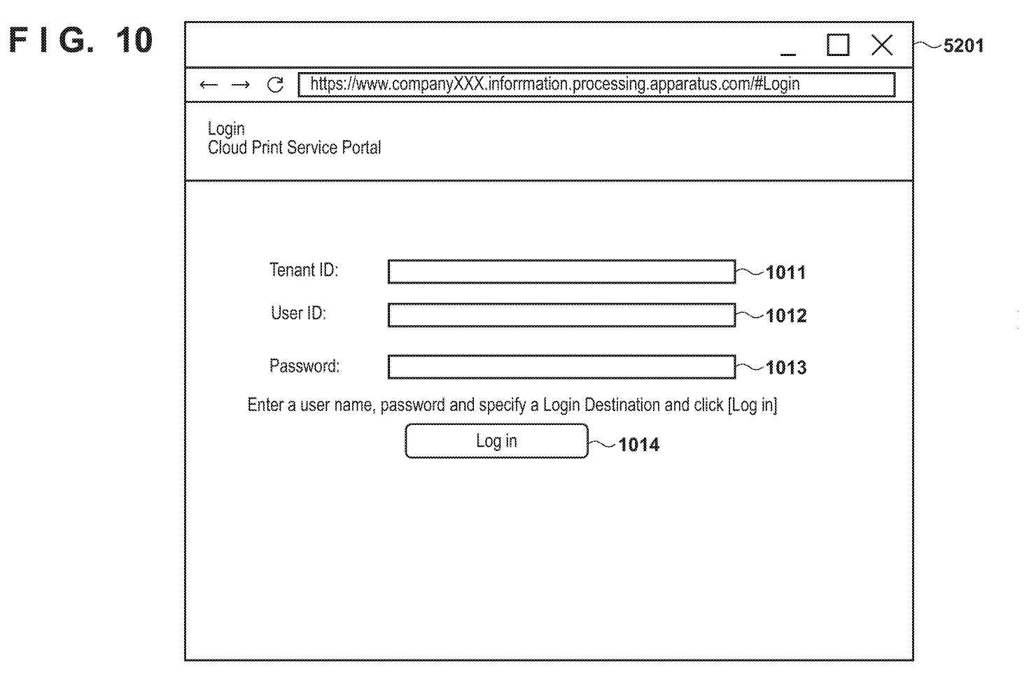

A sequence flow in which various kinds of Web portal screens are displayed on the information processing terminal 51 and a PC application for using the cloud print service 100 in the information processing terminal 51 is installed will be described with reference to FIG. 9. This sequence flow is implemented by the information processing terminal 51 and the cloud print service 100 executing processing while communicating with each other via the network 10. Processing of the information processing terminal 51 is implemented by reading out a program stored in the ROM 514 to the RAM 513 and executing it by the CPU 512. Similarly, processing of the cloud print service 100 is implemented by reading out a program stored in the ROM 140 to the RAM 130 and executing it by the CPU 120. Note that this sequence flow is executed when the user of the cloud print service 100 activates the Web page display unit 520 such as a Web browser in the information processing terminal 51.

In S901, the Web page display unit 520 receives, from the user, an access request to the Web portal 421 of the cloud print service 100. The Web page display unit 520 requests the screen of the Web portal 421 from the cloud print service 100 via the network communication unit 510.

In S902, the Web portal 421 of the cloud print service 100 accepts the request for a screen of the Web portal 421 via the network I/F 170. The Web portal 421 then transmits an authentication screen used to log in to the Web portal 421 to the information processing terminal 51 via the network I/F 170.

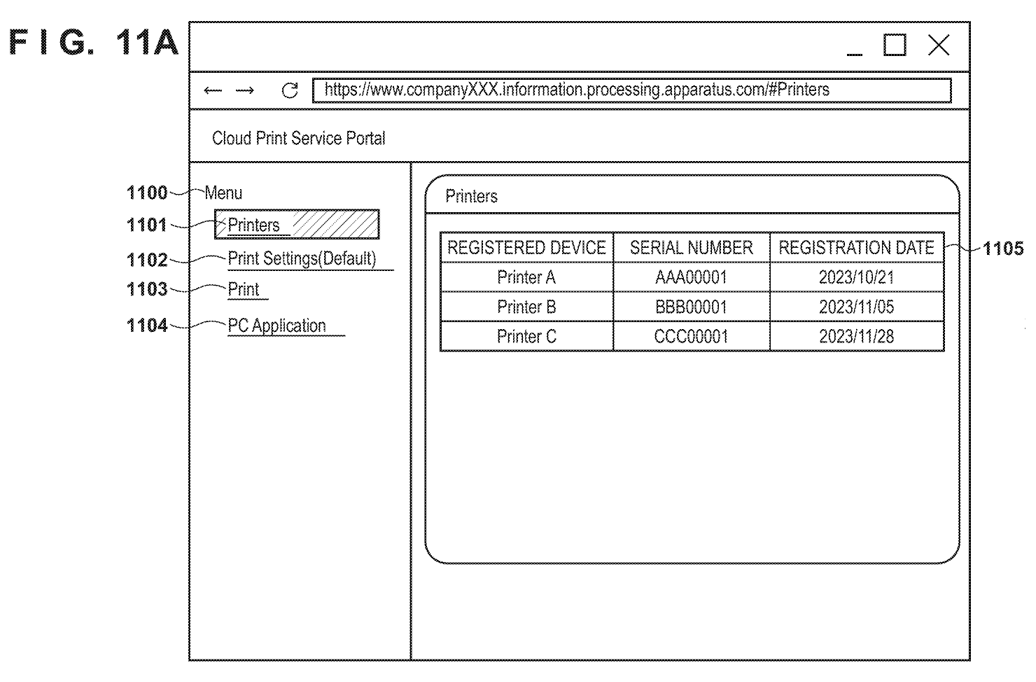

In S903, the network communication unit 510 of the information processing terminal 51 receives the authentication screen. The Web page display unit 520 displays the authentication screen on the operation unit 516. The authentication screen will be described with reference to FIG. 10. On a Web page 5201 displayed on the Web browser of the information processing terminal 51, input fields 1011 to 1013 for a tenant ID, a user ID, and a password, which are information necessary for authentication of the cloud print service 100, are arranged. In addition, a button 1014 that determines input to the input fields 1011 to 1013 is arranged on the Web page 5201. The user inputs authentication information for logging in to the cloud print service 100 to the input fields 1011 to 1013 and performs a touch operation on the button 1014. The Web page display unit 520 then detects the touch operation on the button 1014.

In S904, the Web page display unit 520 transmits an authentication request to the cloud print service 100 together with the authentication information input by the user. In S905, the Web portal 421 of the cloud print service 100 receives the authentication request. The Web portal 421 inputs the received authentication information to the authentication management 413 and, upon receiving this, the authentication management 413 verifies the authentication information. Note that, here, assume that it is determined as the result of authentication information verification that the authentication information is correct information.

In S906, the Web portal 421 transmits the screen of the Web portal 421 to the information processing terminal 51. The network communication unit 510 of the information processing terminal 51 receives the screen of the Web portal 421. In S907, the Web page display unit 520 displays the screen of the Web portal 421 on the operation unit 516.

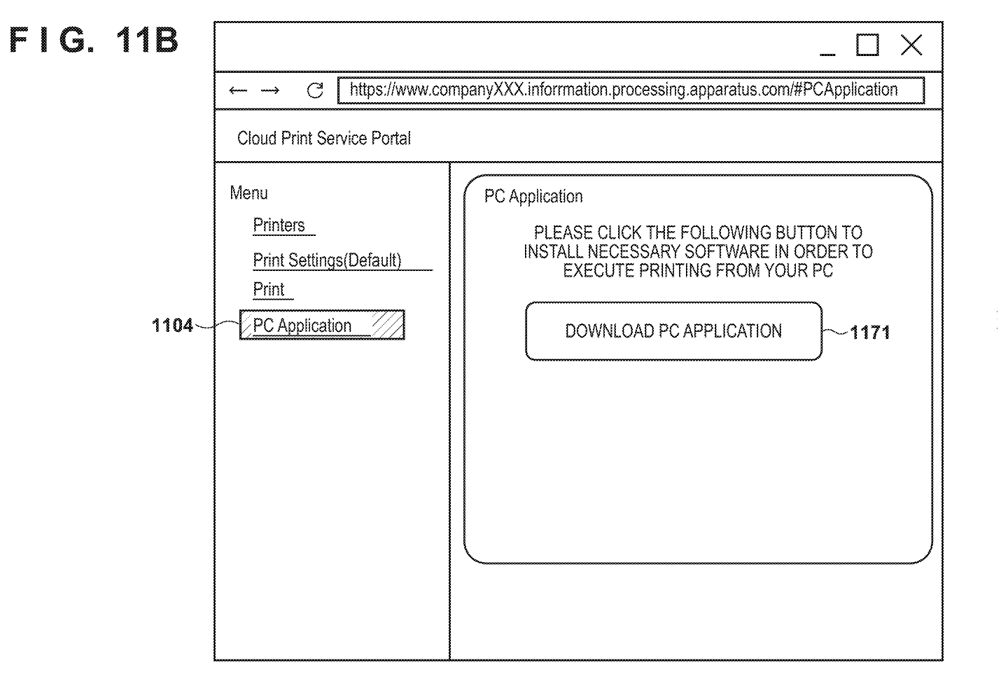

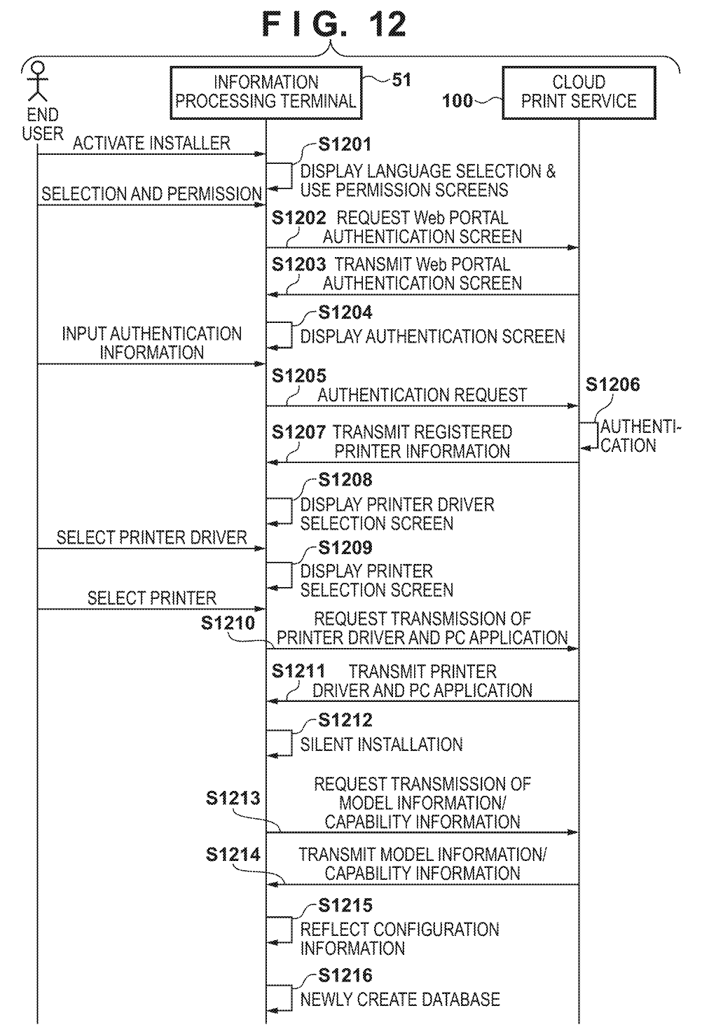

The screen of the Web portal 421 displayed on the Web page 5201 by the Web page display unit 520 will be described with reference to FIGS. 11A and 11B. A menu 1100 is displayed on the left side of the screen of the Web portal 421. As sub menus constituting the menu 1100, a registered printer list menu 1101, a print setting menu 1102, a print instruction menu 1103, and a setting menu 1104 of the PC application 540 are displayed.

More specifically, FIG. 11A exemplifies the screen of the Web portal 421 displayed when the user selects the registered printer list menu 1101. In this screen, the registered printer list 1105 indicating a list of image forming apparatuses 200 registered in the tenant to which the user of the cloud print service 100 authenticated in S905 belongs is displayed. In the registered printer list 1105, the model name (registered device), the serial number, and the registration date of each registered printer (image forming apparatus) are displayed. Note that these display items are merely examples, and other items, for example, the model information or capability information of each registered printer may be displayed.

FIG. 11B exemplifies the screen of the Web portal 421 displayed when the setting menu 1104 of the PC application 540 is selected. In this screen, a button 1171 used to download the installer 530 is displayed. The user of the cloud print service 100 authenticated in S905 performs a touch operation on the button 1171, thereby downloading the installer 530. The user can install the PC application 540 and the printer driver 550 on the PC by operating the installer 530. By this processing, the user can submit a target file as a print job from software, for example, document software, spreadsheet software, or slide creation software installed on the PC. The procedure of installing the PC application 540 and the printer driver 550 and the print instruction procedure will be described later.

Referring back to FIG. 9, in S908, the Web page display unit 520 accepts a touch operation on the screen of the Web portal 421. Here, the Web page display unit 520 accepts input of selecting the setting menu 1104 of the PC application 540 shown in FIG. 11A. The Web page display unit 520 displays the screen shown in FIG. 11B and accepts a touch operation on the button 1171 to download the installer 530. The Web page display unit 520 then transmits a request to download the installer 530 to the cloud print service 100.

In S909, the Web portal 421 of the cloud print service 100 receives the request to download the installer 530, acquires the installer 530 stored in the storage 423, and transmits it to the information processing terminal 51. Note that the format of the installer 530 is the format of an installation execution file or a format in which the information of the tenant to which the user belongs is compressed, and is a format that the user can expand and execute using an OS function of the information processing terminal 51.

In S910, the network communication unit 510 of the information processing terminal 51 receives the installer 530. In the information processing terminal 51 that has received the PC application 540, the installer 530 is activated in accordance with an instruction of the user, for example, an execution instruction for the execution file of the installer. Installation of the PC application 540 and the printer driver 550 and creation of the database 560 are executed. The sequence flow is then ended. Note that details of the sequence processing will be described later.

### Installation Processing of PC Application and Printer Driver

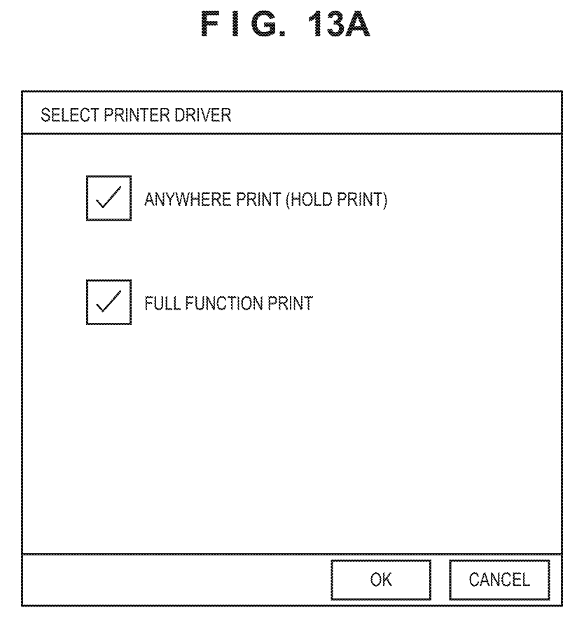

A sequence flow in which the installer 530 downloaded to the information processing terminal 51 is executed, and installation of the PC application 540 and the printer driver 550 and creation of the database 560 are executed will be described with reference to FIG. 12. This sequence is implemented by the information processing terminal 51 and the cloud print service 100 executing processing while communicating with each other via the network 10. Also, processing of the information processing terminal 51 is implemented by reading out a program stored in the ROM 514 to the RAM 513 and executing it by the CPU 512. Similarly, processing of the cloud print service 100 is implemented by reading out a program stored in the ROM 140 to the RAM 130 and executing it by the CPU 120.

In S1201, the installer 530 of the information processing terminal 51 accepts an activation operation from the user via the operation unit 516. The installer 530 then displays a language selection screen and a use permission screen. Selectable languages that the installer 530 displays on the language selection screen are the same as languages displayable on the cloud print service 100. Also, concerning the use permission, the installer 530 displays a permission message indicating that the cloud print service 100 collects data associated with print on the use permission screen for the user.

In S1202, the installer 530 accepts an agreement operation of language selection and use permission by the user. The installer 530 requests the authentication screen of the Web portal 421 to the cloud print service 100 via the network communication unit 510. In S1203, the Web portal 421 of the cloud print service 100 that has received the request transmits an authentication screen for logging in to the Web portal 421 to the information processing terminal 51 via the network I/F 170.

In S1204, the installer 530 of the information processing terminal 51 receives the authentication screen of the Web portal 421 via the network communication unit 510. The installer 530 then displays the Web page 5201 (the same screen as in FIG. 10) for authentication as WebView using the authentication screen. The input fields 1011 to 1013 and the button 1014 capable of instructing login to the cloud print service are arranged on the Web page 5201. At this time, in the input field 1011 in which the tenant ID can be input, the installer 530 refers to tenant information included in the package of the installer 530 and displays the tenant ID in advance. Hence, the user inputs authentication information for logging in to the cloud print service 100 to the remaining input fields (1012 and 1013) and presses the button 1014 to determine the input.

In S1205, the installer 530 accepts authentication information input to the input fields 1011 to 1013 of the Web page 5201. Then, the installer 530 transmits an authentication request to the cloud print service 100 via the network I/F 270 together with the authentication information input by the user. In S1206, the Web portal 421 of the cloud print service 100 transmits the received authentication information to the authentication management 413. The authentication management 413 verifies the received authentication information. Here, assume that verification of the authentication information succeeds.

In S1207, the Web portal 421 acquires a list of printers registered in the tenant to which the authenticated user belongs and printer drivers corresponding to the printers from the database 424. The Web portal 421 transmits the printer list information and the printer drivers to the information processing terminal 51 via the network I/F 170. In S1208, the installer 530 of the information processing terminal 51 receives the printer list information and the printer drivers via the network I/F 270. The installer 530 first displays a printer driver selection screen.

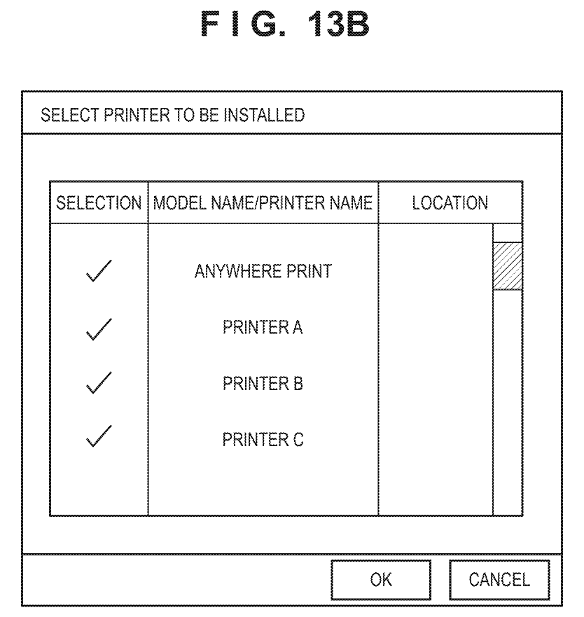

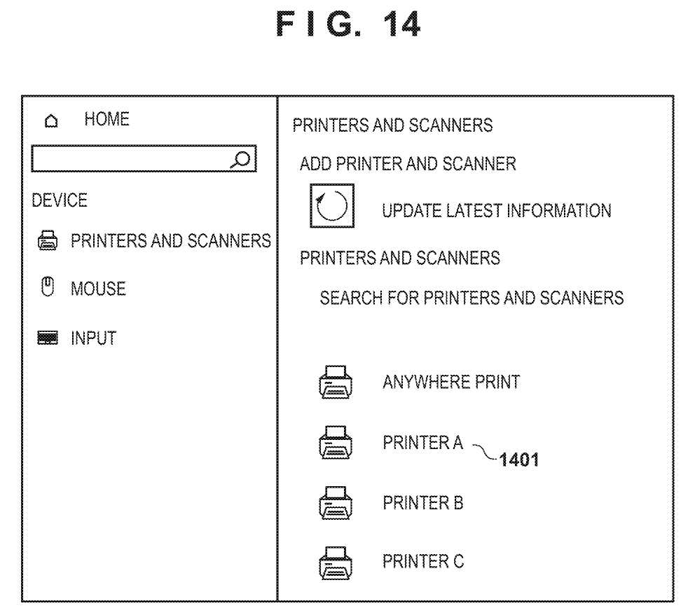

The printer driver selection screen will be described with reference to FIG. 13A. As printer driver options 601, the installer 530 displays a printer driver for anywhere print and a printer driver for full function print. The printer driver for anywhere print is a printer driver configured to accept general-purpose print settings common to a plurality of printers such that after print job generation, print can be performed using the print job regardless of the printer to which the user has logged in. On the other hand, the printer driver for full function print is a printer driver capable of accepting a setting of a function specific to each printer (for example, if a printer has a staple function or a folding function, setting of the function). That is, it can be indicated that the printer driver for anywhere print is a printer driver capable of doing general-purpose settings, and the printer driver for full function print is an advanced printer driver capable of doing even settings specific to each printer. Note that the printer driver for full function print according to this embodiment can set a function specific to a printer in accordance with the setting of the printer as the print job transmission destination, but the present disclosure is not limited to this. For example, a dedicated advanced printer driver may be provided for each printer model. The user can select and install a printer driver shown in FIG. 13A. Note that the user may simultaneously select the printer driver for anywhere print and the printer driver for full function print.

In S1209, when the user selects a printer driver on the printer driver selection screen and then operates the OK button, the installer 530 further displays a printer selection screen in which a printer registered in the tenant can be selected. A print queue according to the printer selected here is generated in S1212 to be described later. The printer selection screen will be described with reference to FIG. 13B. Here, if the user selects "anywhere print" in the printer driver selection screen in FIG. 13A, a print queue for anywhere print needs to be generated. Hence, an option "anywhere print" is displayed, as shown in FIG. 13B. Also, if the user selects "full function print" in the printer driver selection screen in FIG. 13A, printers registered in the tenant are displayed as options to cause the user to select a printer for which a print queue should be generated. That is, if the user selects "full function print" in FIG. 13A, "printer A", "printer B", and "printer C" registered in the tenant to which the user belongs are displayed as options, as shown in FIG. 13B. That is, "full function print" in FIG. 13A is linked with "printer A", "printer B", and "printer C" in FIG. 13B. Note that the printers displayed on the printer selection screen may be limited in accordance with the authority of the user registered in the tenant.

In S1210, the user performs a printer selection operation on the printer selection screen and then operates the OK button. The installer 530 then requests the cloud print service 100 to acquire the printer driver 550 selected by the user, the PC application 540, and a port monitor via the network I/F 517. In S1211, the CPU 120 of the cloud print service 100 acquires the printer driver 550, the PC application 540, and the port monitor stored in the storage 423. The CPU 120 transmits the printer driver 550, the PC application 540, and the port monitor to the information processing terminal 51 using the network I/F 170.

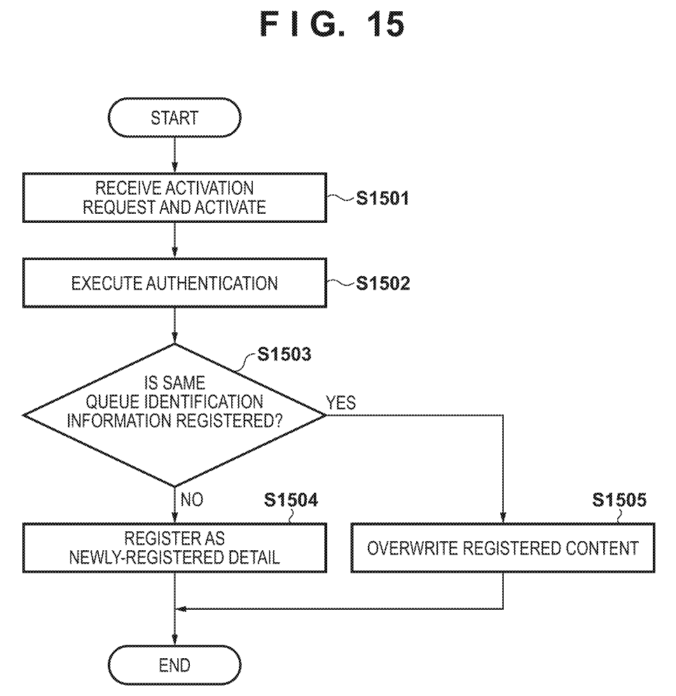

In S1212, the installer 530 of the information processing terminal 51 receives the port monitor, the PC application 540, and the printer driver 550. The installer 530 executes silent installation in this order. A device information screen managed by the OS 360 will be described with reference to FIG. 14. When the installation of the printer driver 550 is completed, the OS 360 generates a print queue having the name selected in FIG. 13B and additionally displays the print queue name in a region 1401 where the list of printers is displayed in the device information screen. For print queues added as "printer A", "printer B", and "printer C", in S1215 to be described later, configuration information concerning a function specific to the printer designated by the user is added. The print queue name to be displayed is acquired from the cloud print service 100, and information about the printer designated by the user is reflected. Here, for example, the model name of the printer designated by the user on the printer selection screen in FIG. 13B is used as the print queue name. Note that the print queue for anywhere print is used for anywhere print (hold print) by default but can also be used when printing without holding the print job by a setting in the PC application 540 (to be described later in detail).

In S1213, installation of the port monitor, the PC application 540, and the printer driver 550 is completed. The installer 530 then transmits the identification information of the printer designated by the user to the cloud print service 100 via the network I/F 517 and requests the model information and capability information of the printer. In S1214, the CPU 120 of the cloud print service 100 receives the request via the network I/F 170 and acquires the model information and capability information of the printer from the list of printer information registered in the database 424 based on the identification information. The CPU 120 transmits the model information and capability information of the printer to the information processing terminal 51 via the network I/F 170.

In S1215, the installer 530 receives the model information and capability information of the printer via the network I/F 517. The installer 530 then reflects information including the model information and capability information as configuration information on the print queue of the printer driver 550 installed in S1212.

Note that in this embodiment, assume that configuration information in a format recognizable by a printer is registered on the cloud print service 100. However, if the format of the registered model information and capability information is different from the format of the configuration information recognizable by the printer driver 550, the format of the registered model information and capability information may be converted using an arbitrary conversion method.

In S1216, the installer 530 transfers the printer name corresponding to the print queue generated by installation of the printer driver 550, the identification information held by the print queue, and the identification information of the printer designated by the user to the PC application 540. The PC application 540 newly creates the database 560 for setting a print job transmission method (hold print/direct print) or the information of the output destination device in direct print. Here, the queue identification information is, for example, identification information called a device instance ID that is assigned to the system when a print queue is generated by the installer 530. The processing is then ended.

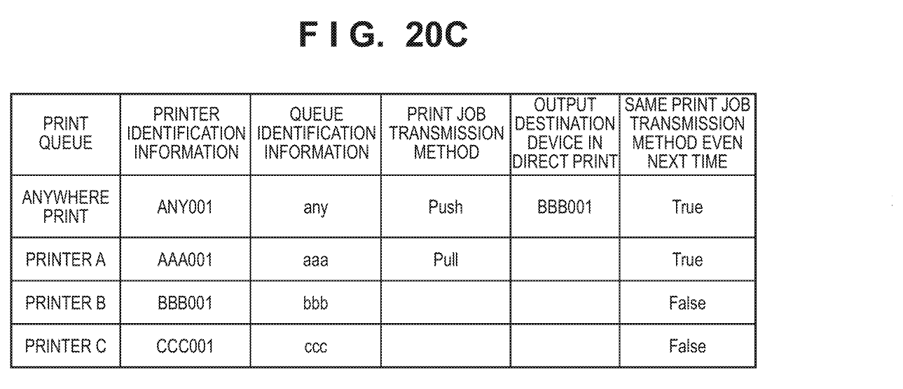

FIG. 20A exemplifies the database 560 newly created in S1216. Note that if the database 560 already exists in the information processing terminal 51, it is not newly created. The database 560 is stored for each account of a user who has logged in to the information processing terminal 51. Details of the registration procedure and configuration of the database 560 will be described later. Note that the identification information held by the print queue will also be referred to as queue identification information hereinafter. The identification information of the printer will also be referred to as printer identification information.

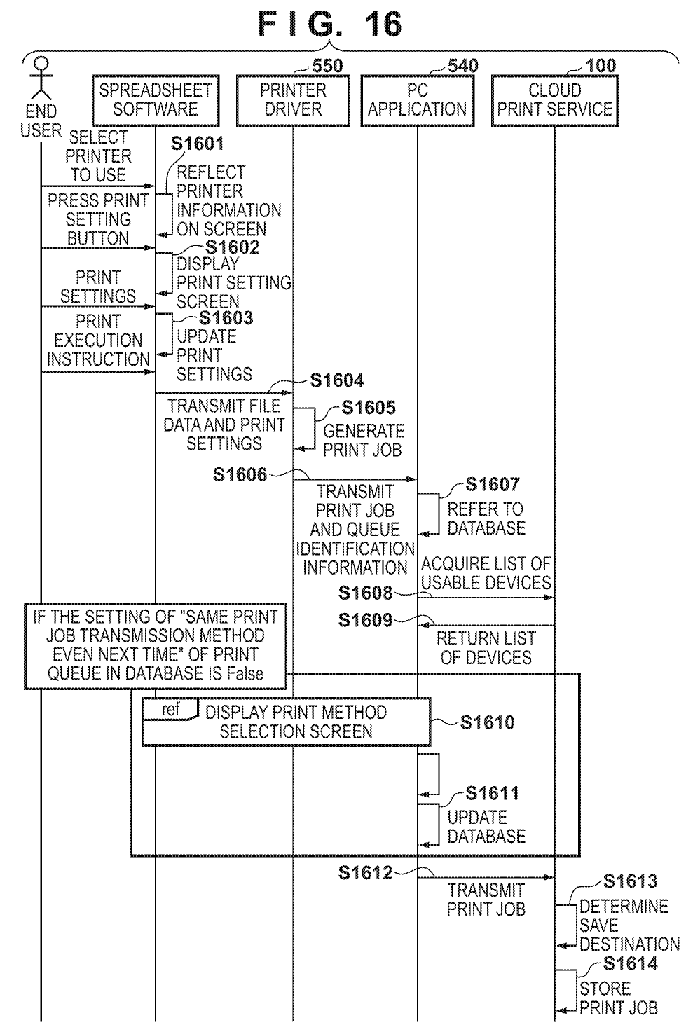

The procedure of processing of registering each identification information by the PC application 540 immediately after being installed in the information processing terminal 51 will be described with reference to FIG. 15. Note that this processing is implemented by reading out a program stored in the ROM 514 of the information processing terminal 51 to the RAM 513 and executing it by the CPU 512.

In step S1501, the PC application 540 is activated upon receiving an activation request from the above-described installer 530. At this time, the PC application 540 receives an access token to the cloud print service 100 such as printer identification information together with the activation request. Here, for identification information linkage to be described later, the PC application 540 receives not only the identification information but also, for example, information such as the model name of the printer.

In step S1502, normally, the PC application 540 requests the user to do authentication for the cloud print service 100 first. However, here, since the access token issued by authentication of the installer 530 is received, authentication is unnecessary. If an error such as expiration occurs later because the access token is expired, the PC application 540 requests the user to do authentication.

In step S1503, the PC application 540 determines whether the same queue identification information is registered in the database 560. If the PC application 540 determines that the queue identification information is registered, the process advances to step S1505. In step S1505, the PC application 540 overwrites the information about the queue identification information. The processing is then ended. On the other hand, if the pc application 540 determines that the queue identification information is not registered, the process advances to step S1504. In step S1504, the PC application 540 newly stores information about the queue identification information. The processing is then ended.

Here, the contents that the PC application 540 stores in the database 560 are, for example, contents obtained by linking the model name of the printer designated by the user, the printer identification information, and the queue identification information of the print queue with the information of setting of the print method. Here, the setting of the print method includes, for example, a print job transmission method (hold print/direct print), the information of the output destination device in direct print, and information representing whether to perform the same print job transmission method next time. Note that, here, the model name of the printer is stored as the name of the print queue in the database 560. However, other information such as the serial number of the printer may be stored in place of the model name of the printer.

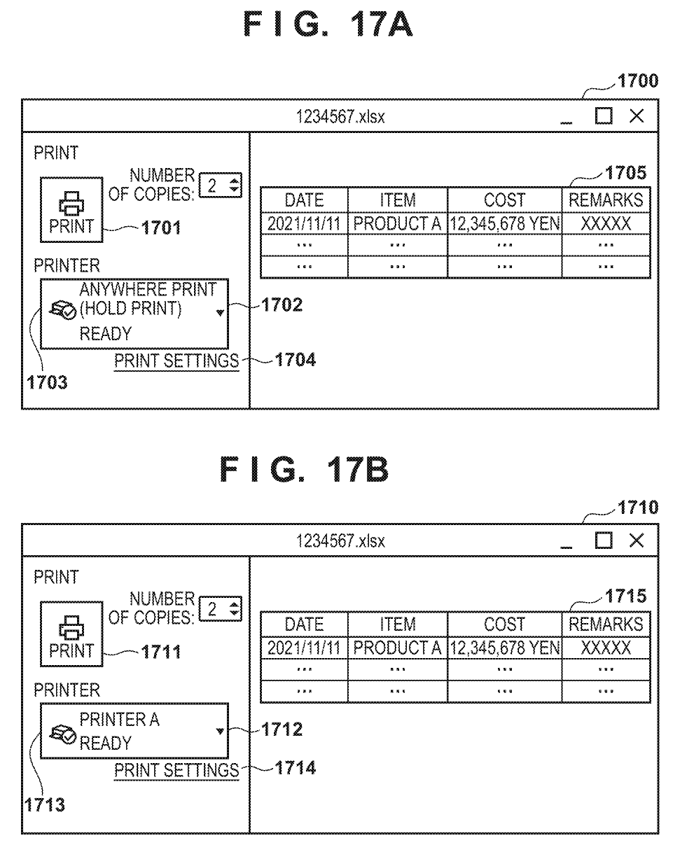

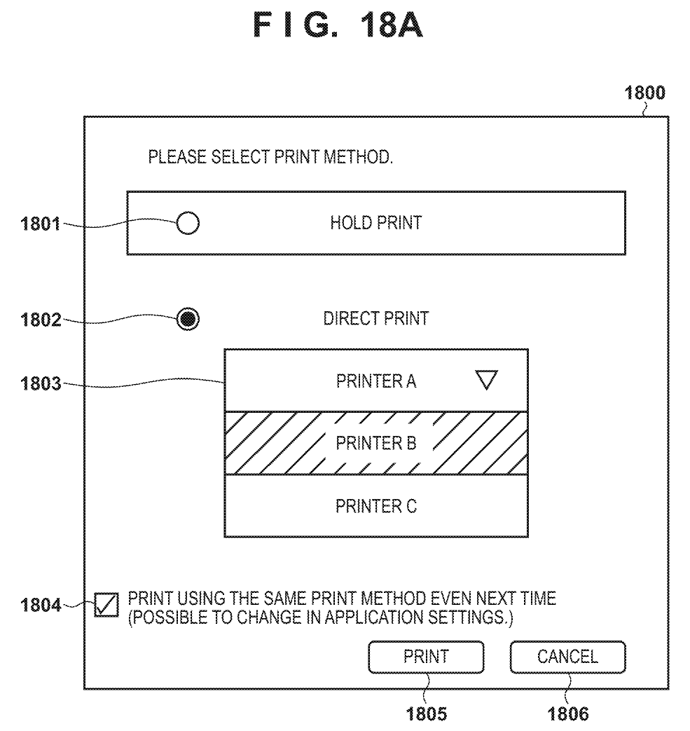

A sequence flow in which the PC application 540 installed in the information processing terminal 51 submits a print job generated by the printer driver 550 to the cloud print service 100 will be described with reference to FIG. 16. This sequence is implemented by the information processing terminal 51 and the cloud print service 100 executing processing while communicating with each other via the network 10. Processing of the information processing terminal 51 is implemented by reading out a program stored in the ROM 514 to the RAM 513 and executing it by the CPU 512. Similarly, processing of the cloud print service 100 is implemented by reading out a program stored in the ROM 140 to the RAM 130 and executing it by the CPU 120. Note that this sequence processing is started when the user of the cloud print service 100 can execute a print operation via a print setting screen or the like on an application such as spreadsheet software shown in FIG. 17A or document creation software. A case where a print instruction is input in spreadsheet software will be described below as an example.

In S1601, the spreadsheet software reflects the name of the print queue on the screen in accordance with a user instruction. For example, FIG. 17A exemplifies a screen 1700 displayed when the user selects an object 1703 indicating the print queue of anywhere print from the print queue selection list displayed in a pulldown menu 1702. Note that the object 1703 indicating the print queue of anywhere print is an example of "first object". In addition, the screen 1700 is an example of "first screen".

In S1602, when the user selects a print setting button 1704, the spreadsheet software displays a print setting screen. In S1603, the spreadsheet software accepts print settings that the user sets on the print setting screen displayed in S1602, and updates existing print settings. The updated print settings are used for subsequent submission data generation processing. In S1604, when the user selects a print button 1701, the spreadsheet software transmits print target file data including print contents 1705 and print setting data set in S1603 to the printer driver 550 linked with the selected print queue.

In S1605, the printer driver 550 generates a print job in a format identifiable by the output destination printer using the file data and the print setting data. Here, the data is converted into a data format according to the type of the printer driver 550. For example, if the printer driver 550 is a PDF driver, the data is converted into the PDF format. If the printer driver 550 is a Generic Plus driver, the data is converted into a printer description language format such as LIPSLX or UFR2.

In S1606, the printer driver 550 transfers the generated print job and the queue identification information of the print queue selected by the user to the PC application 540. In S1607, the PC application 540 refers to the setting of the corresponding print method in the database 560 using the queue identification information acquired in S1606.

Print methods stored in the database 560 will be described with reference to FIGS. 20A to 20C. As shown in FIGS. 20A to 20C, a print queue name, printer identification information, and queue identification information shown on the screen are stored as a print method in the table of the database 560. Note that printer identification information "ANY001" corresponding to "anywhere print" indicates a virtual printer registered in the cloud print service 100. When selecting "anywhere print" and performing hold print, the print job is temporarily held in the cloud print service 100. Upon receiving a print instruction from the image forming apparatus to which the user has logged in, the held print job is transmitted to the image forming apparatus, and print is performed. Note that the printer identification information and the queue identification information shown in the table are fixed information.

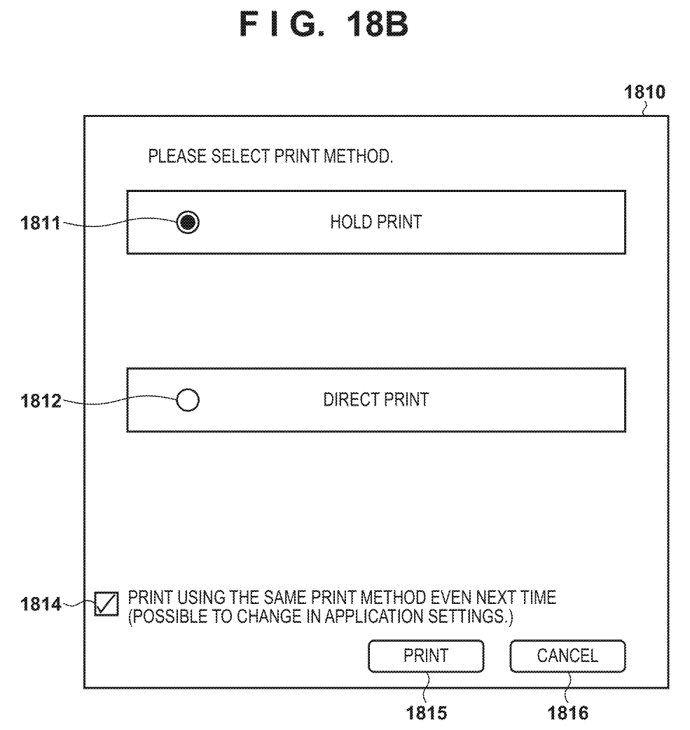

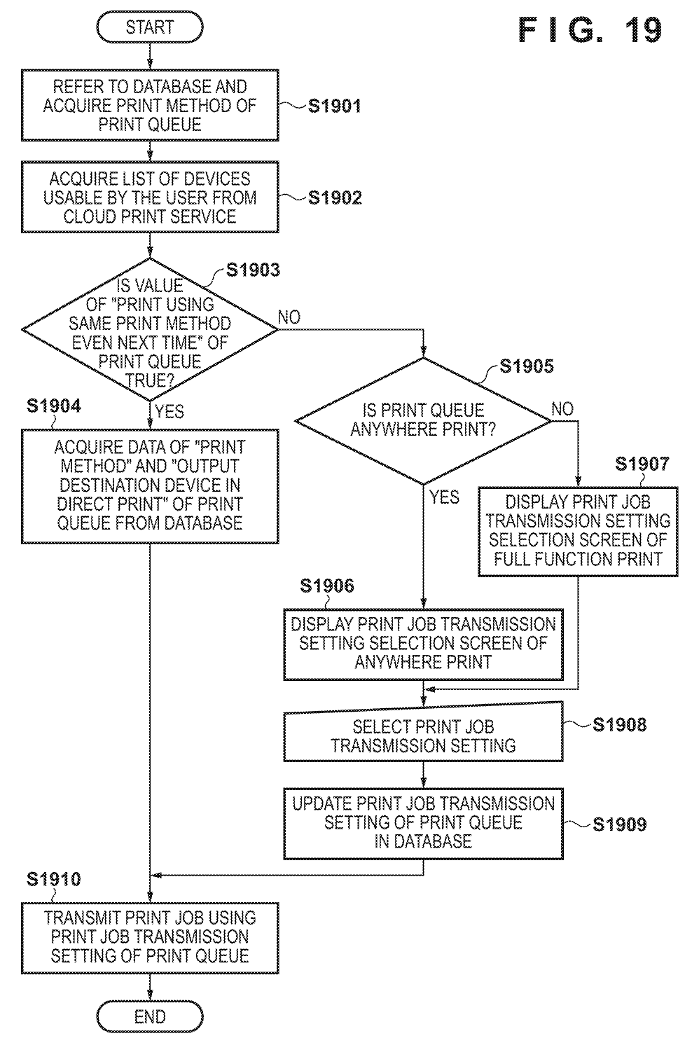

Also, in the table, "print job transmission method", "output destination device in direct print", and "same print job transmission method even next time" are stored. In "print job transmission method", "Pull" indicating hold print in which a print job is temporarily held in the print server or "Push" indicating direct print in which a print job is immediately transmitted to the designated image forming apparatus and print is performed" is stored. In "output destination device in direct print", the identification information of the image forming apparatus 200 selected from a pulldown menu 1803 when the user selects direct print in a selection screen 1800 (to be described later) shown in FIG. 18A is stored. In "same print job transmission method even next time", if a checkmark is put in a check box 1804 of the selection screen 1800 (to be described later) shown in FIG. 18A, "True" is stored. Otherwise, "False" is stored. Note that if "True" is stored, the next print is executed using the "print job transmission method" and "output destination device in direct print" stored in the table.

Note that as the initial information of "print job transmission method", "output destination device in direct print", and "same print job transmission method even next time" in the database 560 (corresponding to FIG. 20A) newly created in S1216, empty data or a value "False" is assigned. Note that the initial information is not limited to empty data or "False". Also, if empty data is assigned to "print job transmission method" and "output destination device in direct print", the items are handled as the standard setting of the print queue. That is, if empty data is assigned to "print job transmission method" of the print queue "anywhere print", the print job transmission method is handled as Pull.

In S1608, the PC application 540 requests the cloud print service 100 to acquire a list of devices usable by the user via the network communication unit 510. In S1609, the CPU 120 of the cloud print service 100 receives the acquisition request using the network I/F 170. The CPU 120 returns the device list stored in the database 424 to the information processing terminal 51 using the network I/F 170. The PC application 540 of the information processing terminal 51 receives the device list. The PC application 540 determines whether the corresponding setting of "same print job transmission method even next time" is "False" in the database 560. If the PC application 540 determines that the setting is "False", the process advances to S1610. If the setting is "True", "print job transmission method" is "Push", and the device set in "output destination device in direct print" does not exist among the usable devices acquired in S1609, the process advances to S1610. For example, if the user's print authority to the device of "output destination device in direct print" stored in the database 560 is eliminated by change of the authority setting or the like, the process advances to S1610. Otherwise, the process skips S1610 and S1611 and advances to S1612.

In S1610, the PC application 540 displays a print method selection screen. FIG. 18A exemplifies the print method selection screen 1800 (an example of "second screen") displayed when anywhere print is selected in S1601. In the selection screen 1800, a radio button 1801 used to select holding a print job in the server (hold print (anywhere print)) is displayed. Also, in the selection screen 1800, a radio button 1802 used to select performing "direct print" for immediately transmitting the print job to the designated image forming apparatus and printing it is displayed. If the user selects direct print, the output destination printer can be selected from a pulldown menu 1803. At this time, as the list of printers (image forming apparatuses) displayed in the pulldown menu 1803, the list of devices usable by the user, which is acquired in S1609, is displayed. Also, a check box 1804 is displayed in the selection screen 1800. If the user selects the check box 1804, when performing print next time using the currently selected print queue (the queue of anywhere print in FIG. 18A), print processing is performed using the same settings as previous. Hence, after S1609, S1610 and S1611 are not executed, and the process advances to S1612.

In addition, a print execution button 1805 and a cancel button 1806 are displayed in the selection screen 1800. When the print execution button 1805 is selected, in S1611, the PC application 540 executes the following processing. That is, the PC application 540 updates the setting of the print method of the print queue (in the example of FIG. 18A, the queue of anywhere print) existing in the database 560 to the setting information selected in the selection screen 1800. On the other hand, if a touch operation is performed on the cancel button 1806, the spreadsheet software transmits the print job by the print method at the start of S1610.

FIG. 20B exemplifies table information updated when the user selects the object 1703 indicating the print queue of anywhere print in the screen 1700 (FIG. 17A) and changes the print method in FIG. 18A. For example, the user selects the radio button 1802 of direct print in the selection screen 1800 (FIG. 18A). Furthermore, the user selects the printer B from the pulldown menu 1803, checks the checkbox 1814 indicating that print is performed next time by the same print method, and selects the print execution button 1805.

Then, the PC application 540 accepts these pieces of information. The PC application 540 stores "Push" determined as direct print in "print job transmission method" associated with the print queue "anywhere print" for generating a print job of hold print in the database 560. Also, the PC application 540 stores identification information "BBB001" of the printer B in "output destination device in direct print", and stores "True" in "same print job transmission method even next time".

When these settings are stored in the database 560, the following processing is executed from print of next time. That is, assume that in the next print, in the screen 1700 (FIG. 17A), the object 1703 indicating the print queue of anywhere print is selected, and the print button 1701 is selected. In this case, the PC application 540 determines, based on the information acquired in S1609, whether the printer B set as the output destination device in direct print is still usable at this point of time. If the PC application 540 determines that the printer B is usable, the display of the selection screen 1800 (S1610) is skipped. Then, the print job generated by the printer driver of "anywhere print" in S1605 is transmitted to the cloud print service 100. Thus, even for the print queue of "anywhere print" in which a print job of hold print is generated, direct print (Push print) can be performed using the print queue.

Also, if the contents stored in the database 560 are changed, as in FIG. 20B or 20C, the PC application 540 changes the instruction contents of the print job generated in S1605 using the updated contents.

In S1612, the PC application 540 transmits the print job to the cloud print service 100 via the network communication unit 510. At this time, in addition to the print job, the identification information of the printer and information such as the registered device name of the printer are also transmitted as information for specifying the image forming apparatus 200 as the output destination.

In S1613, the print application 414 of the cloud print service 100 receives the print job using the network I/F 270. The print application 414 then determines the image forming apparatus 200 that executes the received print job. The print application 414 may perform the determination based on the format of the received print job. Alternatively, the print application 414 may determine the image forming apparatus 200 based on the identification information of the printer or information such as the registered device name of the printer, which is information for specifying the image forming apparatus 200 of the output destination received together with the print job.

In S1614, the print application 414 stores the determination result of S1613 and the print job in the storage 423. That is, the print application 414 stores, in linkage with the information of the print job, information (a user ID or the like) capable of identifying the user who has submitted the print data and the information of the image forming apparatus 200 that is determined in S1613 and executes print. Note that upon determining that the print job is a print job generated by the printer driver for hold print and hold print is designated in FIG. 18A, the print application 414 executes the following processing. That is, the print application 414 may add, for example, information indicating hold print, like a character string "any" representing an arbitrary registered printer, to the print job and store it. The processing is then ended.

As described above, if the queue of anywhere print is selected via the display screens shown in FIGS. 17A and 18A, the print job transmission method (hold print/direct print) and the output destination device in direct print are set and stored. Such processing can be executed even for a print queue of full function print. Note that in the print queue of full function print, direct print is performed by a corresponding image forming apparatus (for example, the printer A, the printer B, the printer C, or the like) by default. On the other hand, the print queue of full function print may be changed to hold print (Pull print) by the corresponding image forming apparatus, as will be described later.

More specifically, FIG. 17B exemplifies a screen 1710 of spreadsheet software different from FIG. 17A. The screen 1710 shows a state in which an object 1713 indicating a print queue capable of instructing direct print by the printer A is selected in a pulldown menu 1712. Note that the printer driver of full function print is associated with the object 1713 of the printer A, and advanced print settings can be done. Also, the print queue 1713 shown in FIG. 17B is set to perform direct print by the printer A by default. However, hold print (Pull print) by the printer A can be set via the screen shown in FIG. 18B to be described later.

Even in a case where the object 1713 of the print queue of the printer A is selected and the print job for full function print is generated, the PC application 540 performs the process of S1607. In S1607, if the setting of "same print job transmission method even next time" of the printer A in the database 560 is "False", the following processing is executed. That is, as in a case where anywhere print is selected, the PC application 540 displays a print method selection screen 1810 (FIG. 18B) in S1610.

The selection screen 1810 is displayed when, for example, the print queue "printer A" is designated. In the selection screen 1810, a radio button 1811 used to select performing hold print and a radio button 1812 used to select performing direct print are displayed. Also, in the selection screen 1810, a checkbox 1814, a print execution button 1815, and a cancel button 1816 are displayed.

The difference between the selection screen 1810 and the selection screen 1800 will be described here. The printer driver of full function print is associated with the print queue "printer A" selected in the screen 1710 in FIG. 17B, and "printer A" is already determined as the output destination device. Hence, in the selection screen 1810 shown in FIG. 18B, the pulldown menu 1803 that enables selection of the output destination device, as in FIG. 18A, is not displayed.

The user selects the object 1713 indicating the print queue of the printer A in the screen 1710 (FIG. 17B), and selects the radio button 1811 indicating hold print in the selection screen 1810 (FIG. 18B) displayed after that. Furthermore, the user checks the checkbox 1814 indicating performing print by the same print method even next time. FIG. 20C shows the database after the user operation.

In this case, in the database 560, in "print job transmission method" associated with the print queue "printer A", "Pull" determined as hold print is stored. In "same print job transmission method even next time", "True" is stored. When these settings are stored in the database 560, the following processing is executed from print of next time. That is, in the next print, in the screen 1710 (FIG. 17B), when the object 1713 indicating the print queue "printer A" is selected, and a print button 1711 is selected, the following processing is executed. That is, the display of the selection screen 1810 (S1610) is skipped, and the print job is transmitted to the cloud print service 100. Thus, even in the print queue of full function print, hold print can be designated.

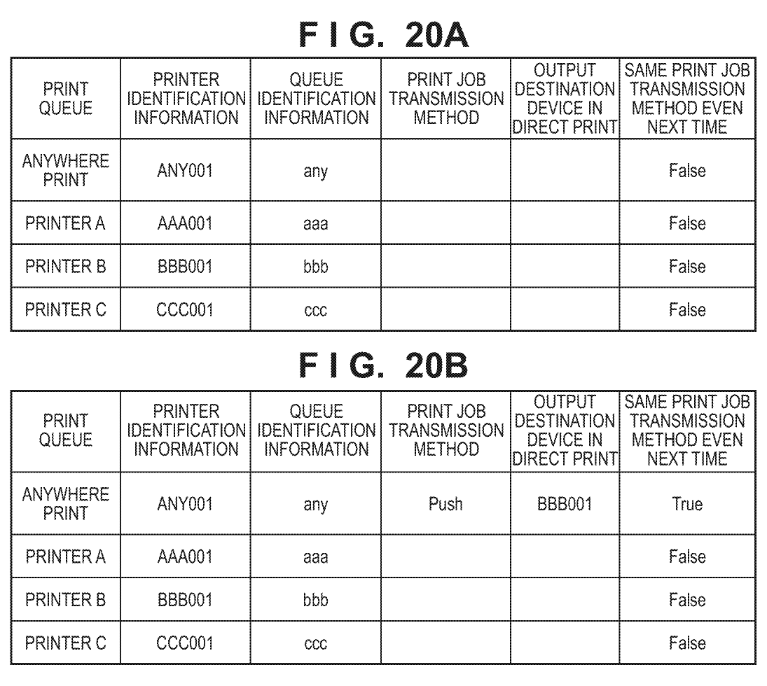

Processing of setting and storing the print method of a print queue for which a print instruction is input in the information processing terminal 51 will be described with reference to FIG. 19. Note that this processing is implemented by reading out a program stored in the ROM 514 to the RAM 513 and executing it by the CPU 512. Also, this processing corresponds to the processing of the information processing terminal 51 in S1607 to S1612 of the sequence flow shown in FIG. 16.

In step S1901, the PC application 540 refers to the database 560 and acquires the print job transmission method of the print queue. In step S1902, the PC application 540 communicates with the cloud print service 100 via the network communication unit 510, thereby acquiring the list of devices usable by the user. In step S1903, using the setting information in the database referred to in step S1901, the PC application 540 determines whether the set value of "same print method even next time" of the print queue is True. If the PC application 540 determines that the set value of "same print method even next time" of the print queue is "True", the process advances to step S1904. In step S1904, the PC application 540 acquires the set values of "print job transmission method" and "output destination device in direct print" of the print queue from the database 560. The process then advances to step S1910. At this time, however, if the print job transmission method is direct print and the output destination device in direct print does not exist in the list of devices usable by the user, the process advances to step S1905.

On the other hand, if the PC application 540 determines in step S1903 that the setting of "same print method even next time" of the print queue is not "True", the process advances to step S1905. Here, the setting in a case where "same print method even next time" is not "True" is, for example, "False", but the information is not limited to this if both can be determined. In step S1905, the PC application 540 determines whether the print queue is a queue of anywhere print. If the PC application 540 determines that the print queue is a queue of anywhere print, the process advances to step S1906.

In step S1906, the PC application 540 displays the print method selection screen 1800 (FIG. 18A) when the print queue "anywhere print" is selected. The process then advances to step S1908. On the other hand, if the PC application 540 determines in step S1905 that the print queue is not a queue of anywhere print, the process advances to step S1907. In step S1907, the PC application 540 displays the print method selection screen 1810 (FIG. 18B) when a print queue for controlling the order of instructions of full function print is selected. The process then advances to step S1908.

In step S1908, the PC application 540 acquires the print job transmission method selected by the user in the selection screen (1800 or 1810). In step S1909, the PC application 540 updates the print job transmission method of the print queue in the database 560 to the transmission method acquired in step S1908. If changes of "output destination device in direct print" and "same print job transmission method even next time" are acquired, these pieces of information are updated in the database 560. In step S1910, the PC application 540 transmits the print job to the cloud print service 100 via the network communication unit 510 using the transmission method of the corresponding print queue. The processing is then ended.

### One Aspect of Function/Effect

According to the image forming system 1 as described above, even if a queue of "anywhere print" is used, the PC application 540 can change the setting to direct print and transmit the print job. Hence, in the information processing terminal 51 in which the print queue of "anywhere print" is already introduced but the printer driver of full function print or a print queue corresponding to each printer is not installed yet, the following processing can be performed. That is, in the information processing terminal 51, direct print can be performed using the print queue of "anywhere print". In the information processing terminal 51 in this state, a step of newly introducing the queue for full function print can be omitted. Hence, if the user wants to change the print method, usability degradation can be suppressed.

Furthermore, according to the image forming system 1 of the first embodiment, information of the print job transmission method (hold print/direct print) or the output destination device in direct print can be linked with the print queue selected by the user and set and stored. Hence, if "print using the same print method even next time" is set in the selection screen 1800 shown in FIG. 18A, display of the selection screen and setting via the selection screen can be omitted. This can also suppress lowering of usability.

### Second Embodiment

In the first embodiment, as shown in FIG. 18A, the following processing is executed at a timing when the print execution button 1805 in the selection screen 1800 is selected. That is, for the print queue of anywhere print, pieces of information of the print job transmission method (hold print/direct print) and the output destination device in direct print are set and stored. On the other hand, in the second embodiment, the pieces of information of the print job transmission method (hold print/direct print) and the output destination device in direct print can be set and stored for the print queue of anywhere print at a timing other than an instruction to execute print. That is, for example, when a PC application 540 is activated from a task tray, the user can set and store the pieces of information of the print job transmission method (hold print/direct print) and the output destination device in direct print at an arbitrary timing.

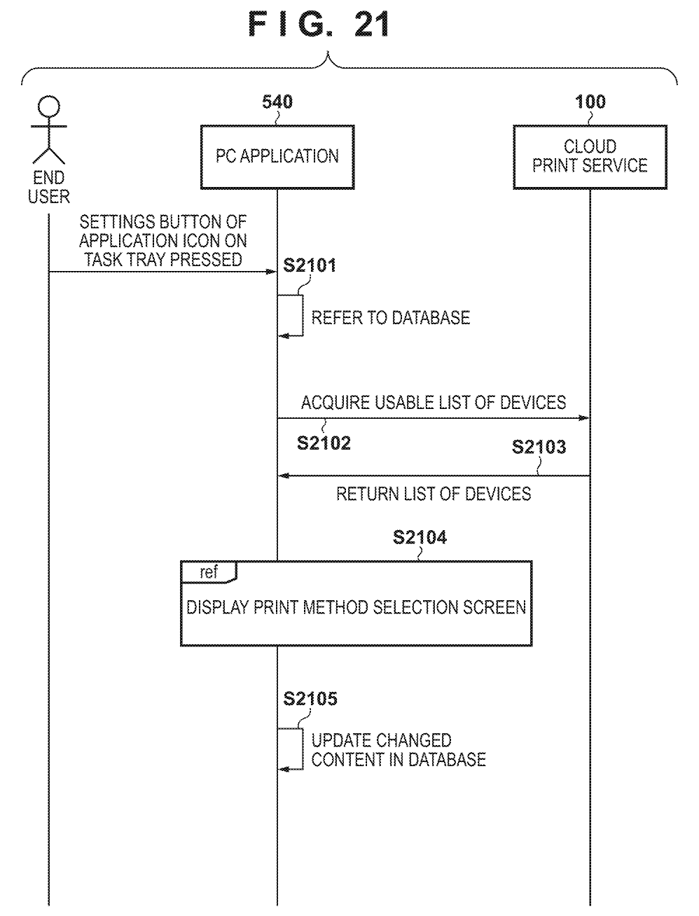

A sequence flow executed by activation of the PC application 540 from an application icon 2202 on a task tray 2201 will be described with reference to FIG. 21. The activated PC application 540 sets and stores the pieces of information of the print job transmission method (hold print/direct print) and the output destination device in direct print for each print queue. This sequence flow is implemented by an information processing terminal 51 and a cloud print service 100 executing processing while communicating with each other via a network 10. Processing of the information processing terminal 51 is implemented by reading out a program stored in a ROM 514 to a RAM 513 and executing it by a CPU 512. Similarly, processing of the cloud print service 100 is implemented by reading out a program stored in a ROM 140 to a RAM 130 and executing it by a CPU 120.

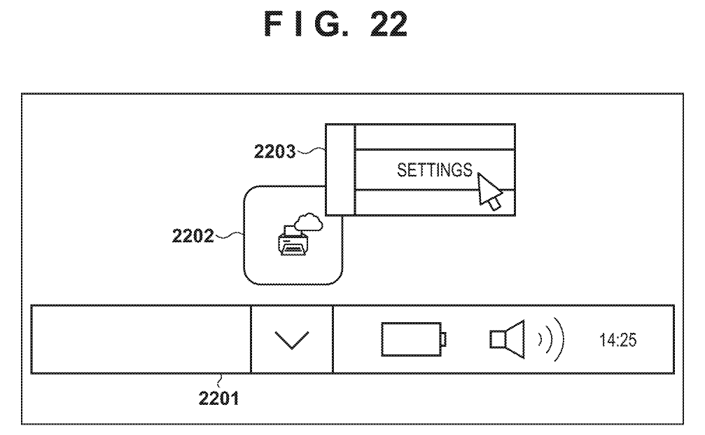

FIG. 22 exemplifies an enlarged view of a notification region (task tray screen) in a task bar displayed on the display of an operation unit 516 of the information processing terminal 51. The task tray screen includes the task tray 2201, the application icon 2202, and a "settings" button 2203. More specifically, using the mouse or the like of the operation unit 516, the user selects the icon of the PC application 540 in the application icon 2202 on the task tray 2201. Then, the CPU 512 accepts the operation and displays the "settings" button 2203. When the user operates the "settings" button 2203, the CPU 512 accepts the operation. The following sequence flow is started by the acceptance of the operation as a trigger.

In S2101, the PC application 540 refers to a database 560 and acquires the information of each print queue stored in the database 560. In step S2102, the PC application 540 requests the cloud print service 100 to acquire a list of devices usable by the user using a network communication unit 510. In S2103, the CPU 120 of the cloud print service 100 receives the acquisition request using a network I/F 170. The CPU 120 returns the device list stored in a database 424 to the information processing terminal 51 using the network I/F 170. The PC application 540 of the information processing terminal 51 receives the device list.

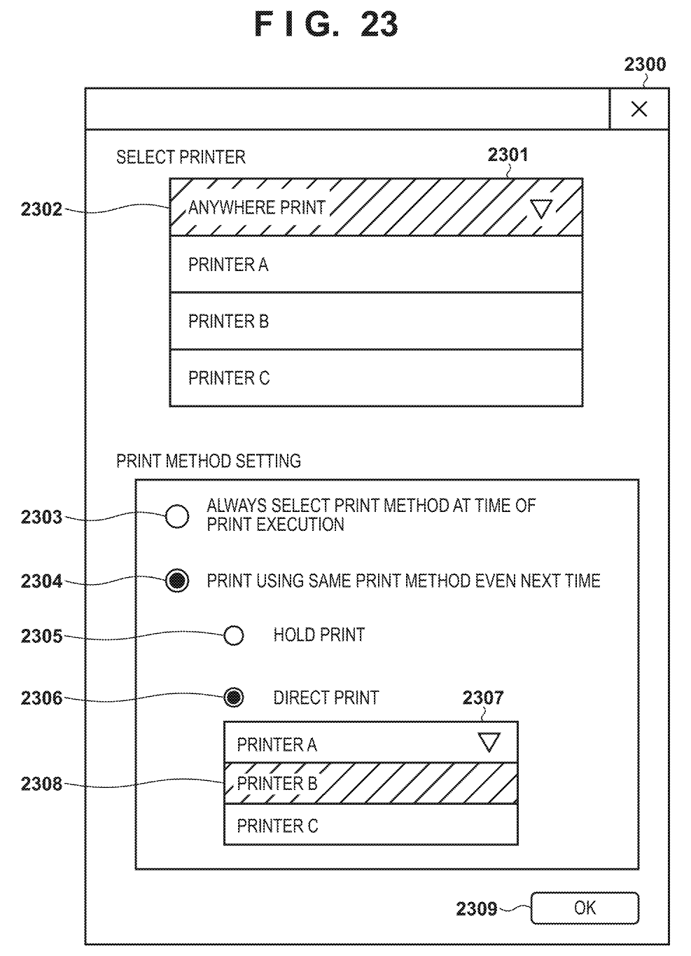

In S2104, the PC application 540 displays a print method selection screen. FIG. 23 exemplifies a print method selection screen 2300 (an example of "second selection screen"). That is, the selection screen 2300 shown in FIG. 23 is an example of a screen displayed when an object 2302 indicating a print queue of anywhere print in the list of print queues in a combo box 2301 is selected. FIG. 23 exemplifies a case where for the print queue of anywhere print, a setting for performing direct print by a printer B is selected, and this setting is applied to next and subsequent times as well.

More specifically, the selection screen 2300 includes the combo box 2301 in which a print queue can be selected. Radio buttons (2303 and 2304) are buttons used to set whether to display the print method selection screen shown in FIG. 18A or 18B at the time of print execution or skip display of the selection screen because the same print method is to be used even next time.

Also, the selection screen 2300 includes radio buttons (2305 and 2306) used to set a print method (hold print/direct print) and a combo box 2307 used to designate the output destination device when direct print is selected. The combo box 2307 includes an object 2308 indicating each printer. The selection screen 2300 also includes an OK button 2309 (an example of "sixth object") used to store, in the database 560, the setting of the print method set in the selection screen 2300.

Note that the selection screen 2300 in FIG. 23 shows an example in which the print queue of anywhere print is selected. Even if a queue of full function print is selected, the setting of the print method can be stored, as in the first embodiment. At this time, like FIG. 18B, the output destination device is already determined in full function print. Hence, in the selection screen 2300, the combo box used to designate the transmission destination device when direct print is selected may not be displayed.

Referring back to the sequence flow in FIG. 21, in S2105, upon accepting the selection operation of the OK button 2309, the PC application 540 updates the setting of the print method of the print queue existing in the database 560 to the setting information selected in the selection screen 2300. The processing is then ended.

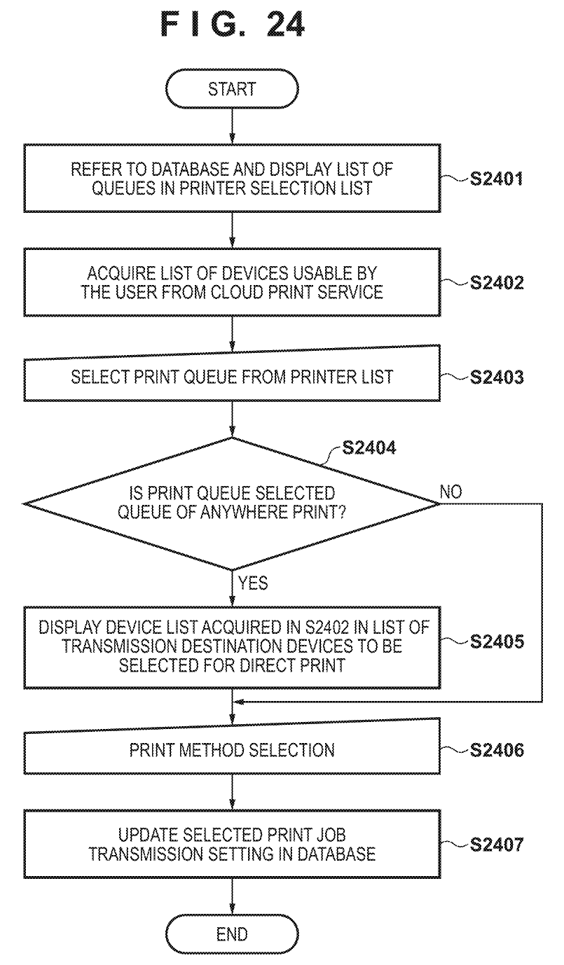

A processing procedure of the information processing terminal 51 in which the print method selected in the selection screen 2300 shown in FIG. 23 is stored in the database 560 will be described with reference to FIG. 24. Note that this processing is implemented by reading out a program stored in the ROM 514 to the RAM 513 and executing it by the CPU 512. Also, this processing corresponds to the processing of the PC application 540 in the sequence flow shown in FIG. 21.

In step S2401, the PC application 540 refers to the database 560, acquires a list of print queues stored in the database, and displays it. In step S2402, the PC application 540 communicates with the cloud print service 100 using the network communication unit 510, thereby acquiring the list of devices usable by the user. In step S2403, the PC application 540 displays the selection screen 2300. The selection screen 2300 includes the names of the print queues acquired in step S2401. The PC application 540 then acquires a print queue selected in the selection screen 2300.

In step S2404, the PC application 540 determines whether the print queue selected in step S2403 is a queue of anywhere print. If the PC application 540 determines that the selected print queue is a queue of anywhere print, the process advances to step S2405. Otherwise, the process advances to step S2406. In step S2405, the PC application 540 displays the device list acquired in step S2402 in the combo box 2307 used to designate the output destination device when selecting direct print. The process then advances to step S2406.

In step S2406, the PC application 540 accepts selection of the print method in the selection screen 2300 and a touch operation on the OK button 2309. In step S2407, the PC application 540 updates the setting of the print method of the print queue existing in the database 560 to the print method selected in the selection screen 2300. Also, the PC application 540 acquires selection of the radio button (2303 or 2304) and the object 2308 in the selection screen 2300. The PC application 540 then refers to the database 560. If the print job transmission setting in the acquired print method is different from the setting in the database 560, the PC application 540 updates the setting in the database 560 to the acquired setting. The processing is then ended.

### One Aspect of Function/Effect

According to an image forming system 1 of the second embodiment, information of the print job transmission method (hold print/direct print) or the output destination device in direct print can be linked with the print queue selected by the user and set and stored. Also, if "print using the same print method even next time" is checked in the screen shown in FIG. 18A of the first embodiment, display of the screen shown in FIG. 18A is skipped next time. However, when the second embodiment is used, the setting for the print queue can be changed again. It is therefore possible to suppress a degradation in usability.

### Modifications

The cloud print service 100 may generate a Web portal screen including objects that enable selection of a print method. The information processing terminal 51 may receive the Web portal screen from the cloud print service 100, and the PC application 540 may display the Web portal screen. The user can set or store a print method from the Web portal screen. The PC application 540 may selectably display the print methods in a screen other than the print setting screens shown in FIGS. 17A and 17B and the selection screens shown in FIGS. 18A and 18B. The PC application 540 may acquire a print method at an arbitrary timing and store it in the database 560.

Also, if the storage state in the database 560 is the state shown in FIG. 20B, and if the PC application 540 accepts selection of the radio button 1801 for performing hold print in the selection screen 1800 (FIG. 18A), the following processing may be executed. That is, the PC application 540 ay assign empty data to "print job transmission method" and "output destination device in direct print" corresponding to the print queue of "anywhere print". Thus, the items stored in the database 560 can be rewritten to other data again or can be deleted.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-226525, filed December 23, 2024, which is hereby incorporated by reference herein in its entirety.

What is claimed is:

1. An information processing apparatus comprising:
one or more memory devices that store a set of instructions; and
one or more processors that execute the set of instructions to:
if a print instruction using a print queue selected by a user is input, control to display a selection screen including an option configured to cause the user to select a print method when performing print processing based on the selected print queue and a setting indicating whether to perform print using the same print method even next time; and
transmit a print job to a print service in accordance with the selected print method,
wherein the one or more processors further execute instructions in the one or more memory devices to:
if the setting to perform print using the same print method even next time is done in the selection screen, and if a next print instruction using the print queue is input by the user, control not to display the selection screen.

2. The information processing apparatus according to claim 1, wherein
the print method displayed as the option includes a first print method of holding the print job in the print service, and a second print method of performing direct print of the print job.

3. The information processing apparatus according to claim 2, wherein the one or more processors further execute instructions in the one or more memory devices to:
if the print queue selected by the user is a print queue with which an image forming apparatus that is an output destination is not associated in advance, control to further display, in the selection screen, an option configured to cause the user to select the image forming apparatus for performing direct print in a case where the second print method is selected.

4. The information processing apparatus according to claim 1, wherein the one or more processors further execute instructions in the one or more memory devices to:
when activated from a notification region displayed on a display of the information processing apparatus, control to display a second selection screen including a list configured to cause the user to select a desired print queue from a plurality of print queues held by the information processing apparatus, an option configured to cause the user to select a print method when performing print processing based on the print queue selected by the user from the list, and the setting indicating whether to perform print using the same print method even next time.

5. A control method of an information processing apparatus capable of communicating with a print service, comprising:
if a print instruction using a print queue selected by a user is input, controlling to display a selection screen including an option configured to cause the user to select a print method when performing print processing based on the selected print queue and a setting indicating whether to perform print using the same print method even next time; and
transmitting a print job to a print service in accordance with the selected print method,
wherein if the setting to perform print using the same print method even next time is done in the selection screen, and if a next print instruction using the print queue is input by the user, control is performed not to display the selection screen.

6. A non-transitory computer-readable storage medium storing a program configured to cause a computer to function to:
if a print instruction using a print queue selected by a user is input, control to display a selection screen including an option configured to cause the user to select a print method when performing print processing based on the selected print queue and a setting indicating whether to perform print using the same print method even next time; and
transmit a print job to a print service in accordance with the selected print method,
wherein if the setting to perform print using the same print method even next time is done in the selection screen, and if a next print instruction using the print queue is input by the user, control is performed not to display the selection screen.
